(19) United States
(12) Patent Application Publication
(10) Pub. No.: US 2026/0184584 A1
(43) Pub. Date: Jul. 2, 2026

(54) SPRAY CALCINATION AND DRYING PROCESS TO PRODUCE HIGH-PURITY ALUMINA

(71) Applicant: Polar Sapphire Ltd., Toronto (CA)

(72) Inventors: Iman Zargaran, Toronto (CA); Scott Nichol, Toronto (CA)

(21) Appl. No.: 19/431,277

(22) Filed: Dec. 23, 2025

Related U.S. Application Data
(60) Provisional application No. 63/740,648, filed on Dec. 31, 2024.

(51) Int. Cl. C01F 7/46; F27B 15/08; F27B 15/14; F27D 99/00

(52) U.S. Cl. CPC C01F 7/46; F27B 15/08; F27B 15/14; F27D 99/0033; C01P 2002/90; C01P 2006/80; F27M 2003/03

(57) ABSTRACT

Processes for preparing high-purity aluminum oxide include providing an aluminum feedstock, reacting the aluminum feedstock with one or more acids to form a hydrated aluminum salt solution, and calcining the hydrated aluminum salt to form an aluminum oxide powder. Other processes for preparing high-purity aluminum oxide include providing an aluminum feedstock and reacting it with one or more acids to form a first hydrated aluminum salt solution, precipitating hydrated aluminum salt from the first hydrated aluminum salt solution to produce a mixture of precipitated hydrated aluminum salt crystals and a mother liquor, separating precipitated hydrated aluminum salt crystals from the mother liquor, dissolving the hydrated aluminum salt crystals in a solvent to form a second hydrated aluminum salt solution, and calcining hydrated aluminum salt of the second hydrated aluminum salt solution to form an aluminum oxide powder. Also described herein are various furnaces for preparing high-purity aluminum oxide.

### CROSS REFERENCE TO RELATED APPLICATION

This application claims the benefit of U.S. Provisional Application No. 63/740,648, filed on Dec. 31, 2024, the entire contents of which are incorporated by reference herein.

### BACKGROUND

High-purity aluminum oxide or alumina powder can be used to make many different structures in various fields, including, but not limited to: translucent tubes for high-pressure sodium lamps; sapphires for watch covers; jewelry stones; high-strength ceramic tools; abrasives for magnetic tape; light emitting diodes as a substrate for GaN; silicon microchip wafers for optic-electronics; windows and cowls for aircrafts; protective windows for car headlamps, cell phones, and other electronic devices; stop signals; surgery scalpels; micro-optical elements of medical fiber-optic probes; optical scanners for bar codes, ultraviolet CD, and DVD optical systems; prisms; lenses; optical plates; optical systems of visual and IR diapasons, cell phone, mobile devices, and fiber-optic system display windows; and equipment for chemical manufacturing in aggressive and high-temperature environments, such as, but not limited to, tubes, crucibles, funnels, chemical glassware, abrasives, battery components, bearings, and semiconductor plasma etching chamber parts.

Currently, the most common methods of making high-purity alumina for manufacturing sapphire for LED substrates are aluminum-ammonium-sulfate thermal decomposition, aluminum-ammonium-carbonate thermal decomposition and aluminum-isopropoxide hydrolyzation. The high-purity alumina is then used in the Verneuil process to make crackle or compressed into densified pucks, granules or beads for melting in a sapphire ingot furnace.

There has been some advancement in a process comprising reacting high-purity aluminum metal with an acid in the presence of water to provide an aluminum salt solution. The aluminum salt solution can then be calcinated in a high-purity crucible or furnace to produce high-purity aluminum oxide. However, using aluminum as the starting raw material for manufacturing high purity aluminum oxide is very difficult because it is difficult to control the reaction rate of the acid with the aluminum. High purity aluminum reacts very slowly with acid and then can very quickly accelerate into a very quick exothermic reaction.

Moreover, at each step of the process, the feedstock or reaction product can be contaminated by the reaction vessel, furnace or holding container. For example, improvements in methods of calcination and the furnace and other equipment used for calcining an aluminum salt solution can result in purity improvements for the final alumina. However, the furnace equipment can provide additional vectors for impurities to enter the aluminum salt solution or the resulting alumina powder. The very high temperatures necessary for aluminum salt calcination can also lead to other difficulties, such as equipment breakage due to thermal shock, incomplete fluidization of the aluminum salt solution or the calcined powder in the furnace and/or material buildup within the furnace, and further drying of the resulting alumina powder.

### SUMMARY

The present disclosure describes processes of producing high-purity aluminum oxide powder by spray calcination (also referred to as “spray roasting”) of a high-purity aluminum salt solution, such as high-purity polyaluminum chloride (PAC), at very high temperature of at least about 450° C., and potentially up to a temperature of 1600° C. or more. The present disclosure also describes processes of spray drying a high-purity aluminum oxide powder, such as the high-purity aluminum oxide powder produced by spray roasting an aluminum salt solution, to produce a dried aluminum oxide powder. The present disclosure further describes furnace apparatuses that can be used for the spray roasting and/or the spray drying processes described herein.

Various non-limiting aspects of processes and furnace apparatuses according to the disclosure are presented below.

In some instances, a first aspect of the disclosure can be described as a process for preparing high-purity aluminum oxide, the process comprising providing an aluminum feedstock, reacting the aluminum feedstock with one or more acids to form a hydrated aluminum salt solution, and calcining the hydrated aluminum salt to form an aluminum oxide powder.

In some instances, a second aspect of the disclosure can be described as a process according to the first aspect, further comprising washing the aluminum feedstock with one or more of water, an acid, a base, a surfactant, a solvent, and an alcohol to remove surface impurities prior to reacting the aluminum feedstock with the one or more acids.

In some instances, a third aspect of the disclosure can be described as a process according to the first or second aspect, wherein the one or more acids comprise sulfuric acid (H₂SO₄), nitric acid (HNO₃), phosphoric acid (H₃PO₄), hydrochloric acid (HCl), and hydrofluoric acid (HF), or any combination thereof.

In some instances, a fourth aspect of the disclosure can be described as a process according to any one of the first through third aspects, wherein the hydrated aluminum salt solution is a polyaluminum chloride (PAC) solution.

In some instances, a fifth aspect of the disclosure can be described as a process according to any one of the first through fourth aspects, wherein calcining is performed by spraying the hydrated aluminum salt solution into a calcination furnace.

In some instances, a sixth aspect of the disclosure can be described as a process according to any one of the first through fifth aspects, further comprising processing the aluminum oxide powder by milling, crushing, or tumbling.

In some instances, a seventh aspect of the disclosure can be described as a process according to any one of the first through sixth aspects, further comprising subjecting the aluminum oxide powder to a magnetic field to remove magnetic impurities therefrom.

In some instances, an eighth aspect of the disclosure can be described as a process according to any one of the first through seventh aspects, further comprising washing the aluminum oxide powder with water, an acid, or a combination thereof, drying the washed aluminum oxide powder, and sintering the dried aluminum oxide powder.

In some instances, a ninth aspect of the disclosure can be described as a process according to the eighth aspect, further comprising melting the sintered aluminum powder to form sapphire therefrom.

In some instances, a tenth aspect of the disclosure can be described as an aluminum oxide powder produced by a method according to any one of the first through eighth aspects.

In some instances, an eleventh aspect of the disclosure can be described as sapphire produced by a method according to any one of the first through ninth aspects.

In some instances, a twelfth aspect of the disclosure can be described as a process for preparing high-purity aluminum oxide, the process comprising providing an aluminum feedstock, reacting the aluminum feedstock with one or more acids to form a first hydrated aluminum salt solution, precipitating at least a portion of the hydrated aluminum salt from the first hydrated aluminum salt solution to produce a mixture of precipitated hydrated aluminum salt crystals and a mother liquor, separating the precipitated hydrated aluminum salt crystals from the mother liquor, dissolving the hydrated aluminum salt crystals in a solvent to form a second hydrated aluminum salt solution, and calcining hydrated aluminum salt of the second hydrated aluminum salt solution to form an aluminum oxide powder.

In some instances, a thirteenth aspect of the disclosure can be described as a process according to the twelfth aspect, wherein calcining is performed by spraying the hydrated aluminum salt solution into a calcination furnace.

In some instances, a fourteenth aspect of the disclosure can be described as a process according to the twelfth or thirteenth aspect, further comprising washing the aluminum oxide powder with water, an acid, or a combination thereof, drying the washed aluminum oxide powder, and sintering the dried aluminum oxide powder.

In some instances, a fifteenth aspect of the disclosure can be described as a process according to the fourteenth aspect, further comprising melting the sintered aluminum powder to form sapphire therefrom.

In some instances, a sixteenth aspect of the disclosure can be described as an aluminum oxide powder produced by a method according to any one of the twelfth through fourteenth aspects.

In some instances, a seventeenth aspect of the disclosure can be described as sapphire produced by a method according to any one of the twelfth through fifteenth aspects.

In some instances, an eighteenth aspect of the disclosure can be described as furnace comprising a cylindrical or substantially cylindrical side wall, a frustoconical bottom wall coupled to and angled inwardly from a vertical bottom end of the cylindrical side wall to vertically cover the bottom of the furnace interior, a domed or rounded top wall coupled to a vertical top end of the cylindrical side wall and vertically covering the top of the furnace interior, one or more combustion burners configured to direct a flame toward the furnace interior with a velocity of flame creating an air flow within the furnace interior, a inlet for supplying a material to be dried or calcined by the furnace, and an outlet for exit of a dried or calcined material from the furnace.

In some instances, a nineteenth aspect of the disclosure can be described as furnace according to the eighteenth aspect, wherein the inlet comprises a spray nozzle.

In some instances, a twentieth aspect of the disclosure can be described as furnace according to the eighteenth or nineteenth aspect, wherein the top wall comprises the inlet.

In some instances, a twenty-first aspect of the disclosure can be described as furnace according to any one of the eighteenth through twentieth aspects, wherein the furnace comprises two combustion burners.

In some instances, a twenty-second aspect of the disclosure can be described as furnace according to the twenty-first aspect, wherein the two combustion burners are configured to produce a counter-current air flow in the furnace interior.

In some instances, a twenty-third aspect of the disclosure can be described as furnace according to the twenty-first aspect, wherein the two combustion burners are configured to produce a whirlwind-like air flow in the furnace interior.

In some instances, a twenty-fourth aspect of the disclosure can be described as furnace according to any one of the eighteenth through twenty-third aspects, wherein the furnace comprises two combustion burners, further comprising a second outlet of exit of a flue gas.

In some instances, a twenty-fifth aspect of the disclosure can be described as an aluminum oxide powder produced by a method according to any one of the first through eighth aspects, the method conducted with a furnace according to any one of the eighteenth through twenty-third aspects.

In some instances, a twenty-sixth aspect of the disclosure can be described as an aluminum oxide powder produced by a method according to any one of the twelfth through fourteenth aspects, the method conducted with a furnace according to any one of the eighteenth through twenty-third aspects.

### BRIEF DESCRIPTION OF THE FIGURES

FIG. 1 is a flow diagram of a non-limiting example process that includes forming a high-purity aluminum salt solution and spraying the aluminum salt solution into a furnace to produce a high-purity aluminum oxide powder.

FIG. 2 is a flow diagram of another non-limiting example process that includes forming a high-purity aluminum salt solution and spraying the aluminum salt solution into a furnace to produce a high-purity aluminum oxide powder.

FIG. 3 is a cut-away side view of a first example furnace that can be used as a calcination furnace or spray drying furnace, for example, in the processes of FIGS. 1 and 2.

FIG. 4 is a cross-sectional view of the first example furnace taken along line 4-4 in FIG. 3.

FIG. 5 is a cut-away side view of a second example furnace that can be used as a calcination furnace or spray drying furnace, for example, in the processes of FIGS. 1 and 2.

FIG. 6 is a cross-sectional view of the second example furnace taken along line 6-6 in FIG. 5.

FIG. 7 is a cut-away side view of a third example furnace that can be used as a calcination furnace or spray drying furnace, for example, in the processes of FIGS. 1 and 2.

FIG. 8 is a cross-sectional view of the third example furnace taken along line 8-8 in FIG. 3.

FIG. 9 is a cut-away side view of a fourth example furnace that can be used as a calcination furnace or spray drying furnace, for example, in the processes of FIGS. 1 and 2.

FIG. 10 is a cross-sectional view of the fourth example furnace taken along line 10-10 in FIG. 9.

FIG. 11 is a flow diagram of an example process for treating or processing a flue gas from a counter-current flow furnace to separate product powder entrained in the flue gas and/or to remove impurities from the flue gas before venting to the atmosphere.

FIG. 12 is a flow diagram of another example process for treating or processing a flue gas from a concurrent flow furnace to separate product powder entrained in the flue gas and/or to remove impurities from the flue gas before venting to the atmosphere.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a recited range of values of “about 0.1 to about 5” should be interpreted to include not only the explicitly recited values of about 0.1 and about 5, but also all individual concentrations within the indicated range of values (e.g., 1, 1.23, 2, 2.85, 3, 3.529, and 4, to name just a few) as well as sub-ranges that fall within the recited range (e.g., about 0.1 to about 0.5, about 1.21 to about 2.36, about 3.3 to about 4.9, or about 1.2 to about 4.7, to name just a few). The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1″” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### Aluminum Oxide Production Process

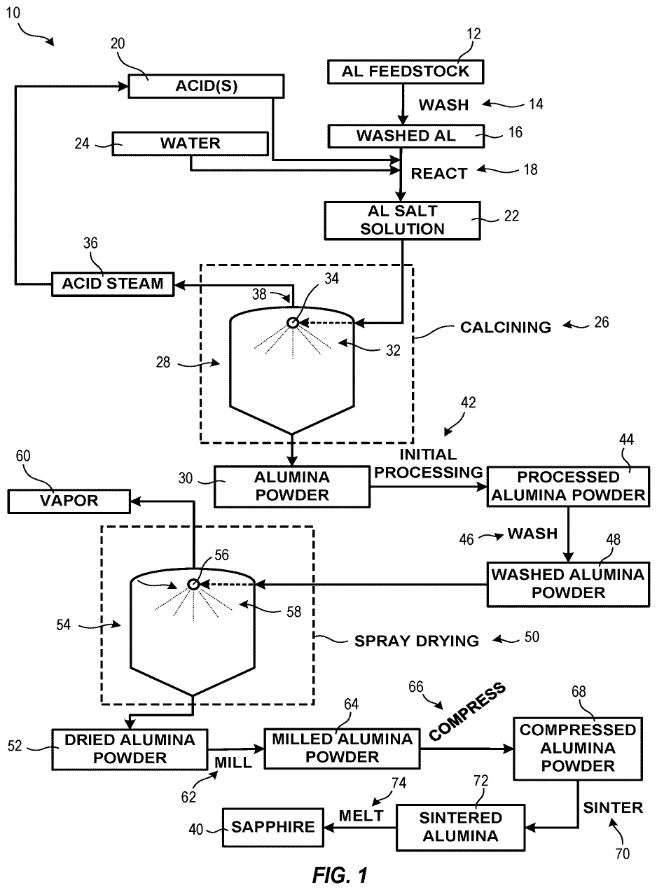

FIG. 1 shows a flow diagram of an example, non-limiting process 10 for producing aluminum oxide, and in particular for producing high-purity aluminum oxide such as synthetic sapphire. As used herein, the term “high-purity aluminum oxide” refers to aluminum oxide having a purity of about 4N (99.99% pure, with total impurities of 0.01%, or 100 ppm) or greater, such as 5N (99.999% pure, with total impurities of 0.001%, or 10 ppm) or greater, for example 6N (99.9999% pure, with total impurities of 0.0001%, or 1 ppm). In some examples, the term “high-purity aluminum oxide” refers to aluminum oxide having a purity in the range of from about 4N to about 6N.

The process 10 processes an aluminum metal feedstock 12 to produce aluminum oxide. The aluminum feedstock can have a purity of at least 99.9 at. % aluminum (e.g., 3N aluminum) or greater, such as 99.98 at. % aluminum or greater, for example 99.99 at. % aluminum (e.g., 4N aluminum) or greater, such as 99.995 at. % aluminum or greater, for example 99.998 at. % (e.g., 4.8N aluminum), such as 99.999 at. % (e.g., 5N aluminum) or greater. In an example, less than 0.02 wt. % of the total impurities are metallic impurities. In an example, each metallic element impurity is less than 0.01 at. %.

In an example, the aluminum feedstock 12 can comprise high-purity aluminum from the three-layer electrolytic process, also known as the Hoope process. High-purity scrap aluminum can also be used as the aluminum feedstock 12, such as electrical conducting wire, lithographic foil, or electrolytic capacitor aluminum foils. In an example, the aluminum feedstock 12 can have less than 20 ppmw metal and alkali impurities. In an example, the aluminum feedstock 12 can have less than about 30 ppmw total impurities. Forms of the aluminum feedstock 12 include, but are not limited to, ingots, sows, chunks, foil, wire, pyramids, powder, or other commercially available forms of aluminum metal or aluminum containing ore.

The process 10 can include, at step 14, optionally washing one or more surfaces of the aluminum feedstock 12 to provide a washed aluminum 16. The surfaces of the aluminum feedstock 12 can be washed 14 by treating the surfaces with a washing medium that can include, but is not limited to, one or more of water, an acid, a base, a soap or other surfactant, a solvent, and an alcohol. In an example, the aluminum feedstock 12 is washed 14 with hydrochloric acid (HCl) by contacting the aluminum feedstock 12 with the HCl for a time that is sufficient to clean the surfaces of the aluminum feedstock 12 to remove a specified portion of surface impurities. In an example, the aluminum feedstock 12 is contacted with a 5-20 wt. % HCl solution for from about 4 hours to about 24 hours, such as by placing the aluminum feedstock 12 in a washing vessel with the HCl solution for the specified period of time. The treated surfaces of the aluminum feedstock 12 can then be rinsed with water to provide the washed aluminum 16. In an example, the water used to rinse the aluminum feedstock 12 after washing 14 is high-purity water.

Next, the process 10 can include, at step 18, reacting aluminum, e.g., the aluminum feedstock 12 or the washed aluminum 16, with one or more acids 20 to provide a hydrated aluminum salt solution 22. Using aluminum as a starting raw material for manufacturing aluminum oxide can be difficult due to difficulties in controlling the reaction rate of the acid with the aluminum. High-purity aluminum reacts very slowly with acid, but the reaction can very quickly accelerate into a fast, exothermic reaction. Moreover, at each step of the process the feedstock can be contaminated by the reaction vessel, furnace or holding container. It can be important to control the reaction and temperature at each step to prevent contamination in the process in order to reach a high purity with a low cost. In the past it has been difficult to react high-purity aluminum economically in acid due to the fact that as the purity of the aluminum increases, the reaction of the aluminum with acid tends to slow down. Use of aluminum with very high surface area can also increase costs and potentially cause a runaway reaction due to the exothermic reaction.

Previous research on using acids to process ores high in aluminum content into aluminum oxide was primarily for the production of alumina for use in manufacturing primary aluminum. These processes are concerned with reaching the purity limits for the Hall-Heroult process, and do not purport to provide for the typical 4-6N purity requirements for producing a sapphire grade sufficient for LED substrates or other high-purity alumina applications. Conventionally-produced alumina powder for sapphire feedstock applications typically have at least the following impurity levels: Na<10 ppmw; Fe<5 ppmw; Si<10 ppmw; Ti<3 ppmw; Mg<2 ppm2; Ca<2 ppmw, and aluminum oxide purity of only about 99.99% (or 4N) purity. Higher alumina purities, such as 5N or greater, as feedstock for sapphire ingots can increase the yield and throughput for sapphire production processes.

In an example, the one or more acids 20 that are reacted with the aluminum feedstock 12 or the washed aluminum 16 can include, but are not limited to, one or any combination of sulfuric acid (H₂SO₄), nitric acid (HNO₃), phosphoric acid (H₃PO₄), hydrochloric acid (HCl), and hydrofluoric acid (HF). The acid can have a high purity, such as an acid having less than 1 ppmw impurities for all elements. In an example, the acid can comprise less than about 1 ppmw of Na, Ca, Li, Fe, Zn, Cu, Ti, Cr, K, and Mg. In an example, the acid can comprise less than about 0.2 ppmw of metallic impurities. The one or more acids 20 can be industrial-grade acids, such as industrial grade HCl, which has been purified via one or more of filtration, an ion-exchange process, distillation, and a diffusion dialysis process.

In an example, the one or more acids 20 can be diluted in water 24 so that the acid is at a specified concentration before or during the reaction 18. The one or more acids 20 and the water 24 can be added to the reaction 18 as the aluminum 16 is being leached. The water 24 can have a high purity, such water that has been purified by one or any combination of deionization, filtration, reverse osmosis, or distillation. As used herein, the term “high-purity water” can refer to water that has been purified by one or any combination of deionization, filtration, reverse osmosis, and distillation. In an example, “high-purity water” can be at least about 99.999 wt. % pure water. In some examples, “high-purity water” can have less than about 0.5 ppmw total impurities, such as less than about 0.2 ppmw total impurities. In an example, “high-purity water” can refer to water having a resistivity of 18 mega ohms×centimeter at 25° C. (MQ·cm at 25° C.) or greater.

In an example, the hydrated aluminum salt solution 22 that is formed from the reaction 18 of the one or more acids 20 and the aluminum 16 in the presence of the water 24 comprises one or more hydrated aluminum salt compounds in water. The reaction 18 of the one or more acids 20 and the aluminum 16 can be referred to as leaching the aluminum 16. The aluminum 16 can be dissolved in the acid 20 to form the hydrated aluminum salt solution 22. The one or more acids 20 and the water 24 can be added in a sufficient amount so that substantially all the hydrated aluminum salt 22 can be dissolved in the liquid. Additional water having a high purity can be added in the form of a diluted high-purity acid or straight high-purity water. In examples where the acid 20 comprises HCl, the hydrated aluminum salt of the hydrated aluminum salt solution 22 comprises hydrated aluminum chlorohydrate, also referred to as polyaluminum chloride (PAC), which is a group of aluminum salts having the general formula AlₙCl₍₃ₙ₋ₘ₎(OH)ₘ. Other examples of solutions that can be formed by the reaction of the aluminum feedstock 12 include, but are not limited to, an aluminum nitride solution (e.g., if the one or more acids 20 include nitric acid (HNO₃)), or an aluminum sulfide (e.g., if the one or more acids 20 include sulfuric acid (H₂SO₄) or hydrosulfuric acid (H₂S)).

The reaction can be run until all or substantially all of the available hydrogen from the acid 20 is released as hydrogen gas (H₂). The hydrated aluminum salt solution 22, such as polyaluminum chloride, which is formed by the reaction 18 can have a density of from about 1.25 grams/cm³ (“g/cc”) to about 1.37 g/cc once all the acid 20 has been reacted. The reaction 18 can take from about 6 hours to about 72 hours for all the acid 20 to be reacted to form the hydrated aluminum salt solution 22.

The reaction 18 can be performed in high-temperature stable and acid resistant reaction vessel, such as a tank, with ventilation for H₂ gas formed during the reaction (not shown). In an example, the reaction vessel can comprise a high-temperature resistant plastic that will be thermally stable at temperatures of at least 25° C. to about 120° C. An interior of the reaction vessel can comprise a non-contaminating material that can resist the chemical conditions of the reaction 18 without contaminating the process with additional impurities, also referred to herein as a “non-contaminating material,” a “non-contaminating tank” or a “non-contaminating vessel.” In an example, the reaction vessel can hold from about 400 L to about 4000 L. Examples of potential reaction vessel materials include, but are not limited to, are polyvinylidene difluoride (PVDF), such as PVDF sold under the trade name KYNAR; polytetrafluoroethylene (PTFE), such as PTFE sold under the trade name TEFLON; fluorinated ethylene propylene (FEP), such as FEP sold under the trade name TEFLON FEP; perfluoroalkoxy alkane (PFA), such as PFA sold under the trade name TEFLON PFA; polyproplyene (PP); or other high temperature plastics that can resist the temperature and chemical attack. The reaction vessel can also comprise a non-chemical resistant base material having a fluorinated coatings, such as a PTFE coating or a PFA coating, or both, an acid-resistant epoxy coating, or a high-temperature plastic coating, such as one of the materials described above.

The reaction vessel can be insulated on some or all sides, including a top and a bottom. The reaction vessel can include a lid that vents to a scrubber or an exhaust. Exhaust fumes from the reaction 18 can go to one or any combination of a scrubber, a condenser, or other device for recycling of the water and acid. The exhaust fumes can be refluxed and condensed acid can be flowed back into the reaction vessel. The reaction vessel can be vented with air to dilute hydrogen level below a lower explosion limit. The vented air can be filtered to remove dust.

The reaction 18 can be limited by the amount of the one or more acids 20 added to the reaction vessel. The one or more acids 20 can be added all at once, metered into the reaction vessel over time, or added at the beginning of the reaction 18 and then further metered in over time. In an example, the aluminum feedstock 12 or the washed aluminum 16 and the water 24 can be added to the reaction vessel, and the one or more acids 20 are metered into the reaction vessel over time at a controlled rate. Additional water 24 can also be metered into the reaction vessel as the one or more acids 20 are metered into the reaction vessel.

At least a stoichiometric amount of the aluminum 12, 16 can be added to the reaction vessel for the reaction 18, but excess aluminum 12, 16 can also be added to the reaction vessel. Excess, unreacted aluminum 12, 16 can be left in the reaction vessel for a subsequent next batch, or the excess, unreacted aluminum 12, 16 can be separated from the hydrated aluminum salt solution 22. In an example, a constant or substantially constant surface area of the aluminum 12, 16 can be used in the reaction vessel from batch to batch, so that aluminum can be added after each batch to replace the aluminum that was reacted in a previous batch. The water 24 and the aluminum 12, 16 can be added to the reaction vessel first followed by metering the one or more acids 20 into the reaction vessel.

The liquid in the reaction vessel can be heated to a temperature of from about 25° C. to about 130° C., such as from about 65° C. to about 110° C. The vessel can be heated using external heat and/or the heat from the exothermic reaction in the vessel. Depending on the composition of the one or more acids 20, e.g., the concentration of the acid in the reactant solution, which can be dictated by the rate of addition of the one or more acids 20 to the reaction vessel, the amount of water 24 in the reaction vessel, and the surface area of the aluminum 12 or 16, the exothermic nature of the reaction between the aluminum 12 or 16 and the acid 20 can provide some or all of the heat necessary for the reaction 18. In some examples, an additional heat source can be used. The vessel can be heated using a heat exchanger in the tank, coated heating elements, or hot fluid pumped through coils or a heat exchanger resistant to the temperature at which the reaction 18 is run and the chemicals present in the reaction vessel.

The liquid in the reaction vessel can be mixed during the reaction 18, for example by rotary stirring of the contents of the reaction vessel, pumping the liquid around the reaction vessel, or another method.

When the reaction 18 occurs with some grades of aluminum, small particles can be seen in the liquid that includes the hydrated aluminum salt solution 22. These small particles can typically be impurities that have not dissolved in the acid mixture. For example, if iron impurities are present in the aluminum feedstock 12 and HCl is used as the acid 20, small black particles can form in the reaction liquid. The lower the purity of aluminum feedstock 12, the more likely that these small particles will be seen in the reaction vessel. Some of the particles will dissolve over time, reducing the purity of the hydrated aluminum salt solution 22, and thus reducing the final purity of the aluminum oxide. Therefore, the hydrated aluminum salt solution 22 can optionally be filtered to remove the impurity particles from the liquid to form a filtered hydrated aluminum salt solution 22. The filtration can take place in conjunction with the reaction 18 or downstream of the reaction 18. In an example, the liquid can be continuously filtered while the reaction 18 is progressing to remove the impurity particles. In an example, at least one of magnetic separation, acid resistant filters, an ion-exchange resin, one or more centrifuges, one or more filter bags, one or more filter cartridges, and settling can be used to accomplish filtration of the hydrated aluminum salt solution 22. Alternative to filtering, or in addition to filtering, the impurity particles can be removed with one or more solvents that can dissolve the particles, but that are not miscible in water so that the solvent with dissolved impurity can be easily removed from the reaction liquid, which is water-based. In examples where the reactant aluminum 12, 16 has sufficiently high purity, these small particles do not appear and thus, in some examples, filtering is not necessary. In some examples, the aluminum feedstock 12 can be of sufficiently high purity such that filtering or removal of impurity particles the hydrated aluminum salt solution 22 is not necessary to achieve acceptable final purity of the aluminum oxide.

In an example, the hydrated aluminum salt solution 22 has less than 3 ppmw total impurities, such as less than 0.5 ppmw of Fe, Na, and Si and less than 0.3 ppmw of all other elements. In other words, other than water, acid, sulfur, carbon, and the hydrated aluminum salt molecules (e.g., PAC), the hydrated aluminum salt solution 22 has only 3 ppmw or less of other impurities.

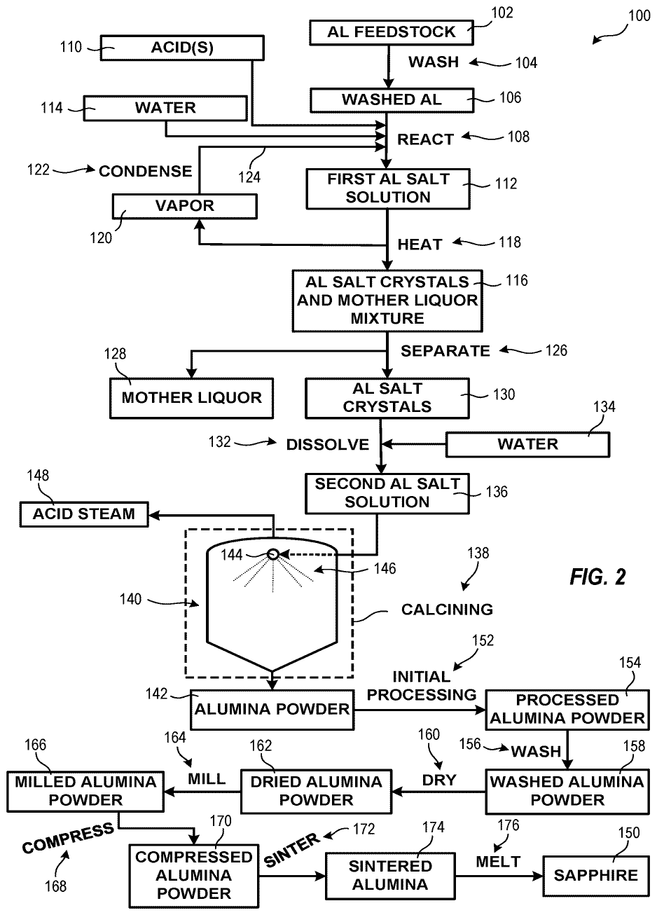

As described in more detail below with respect to FIG. 2, the hydrated aluminum salt solution 22 can be further purified before calcination, such as by precipitation of aluminum salt crystals out of the hydrated aluminum salt solution 22, which can be washed or otherwise purified and redissolved to form a more pure solution. Those having skill in the art will appreciate that there may be other methods of purifying the hydrated aluminum salt solution 22 before performing the spray-roasting calcination described below.

Next, the process 10 can include, at step 26, calcining the one or more hydrated aluminum salt compounds in the solution 22 to convert them to aluminum oxide (also referred to as “alumina”). As shown in FIG. 1, in an example, the hydrated aluminum salt solution 22 is calcined by spraying the hydrated aluminum salt solution 22 into a calcination furnace 28 that is heated to a sufficiently high temperature to convert the one or more hydrated aluminum salt compounds to an alumina powder 30. For simplicity, the step of calcining 26 by spraying the hydrated aluminum salt solution 22 into the furnace 28 will also be referred to as “spray roasting 26” the hydrated aluminum salt solution 22.

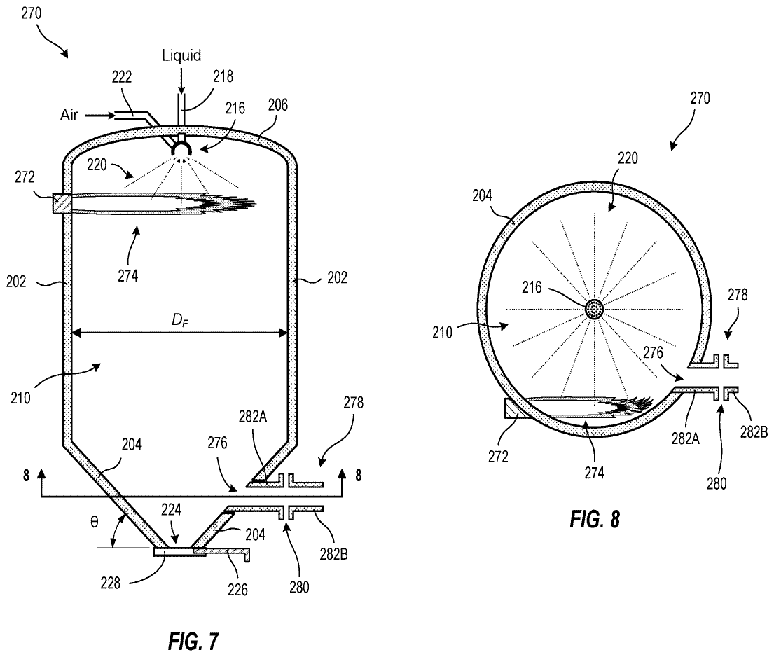

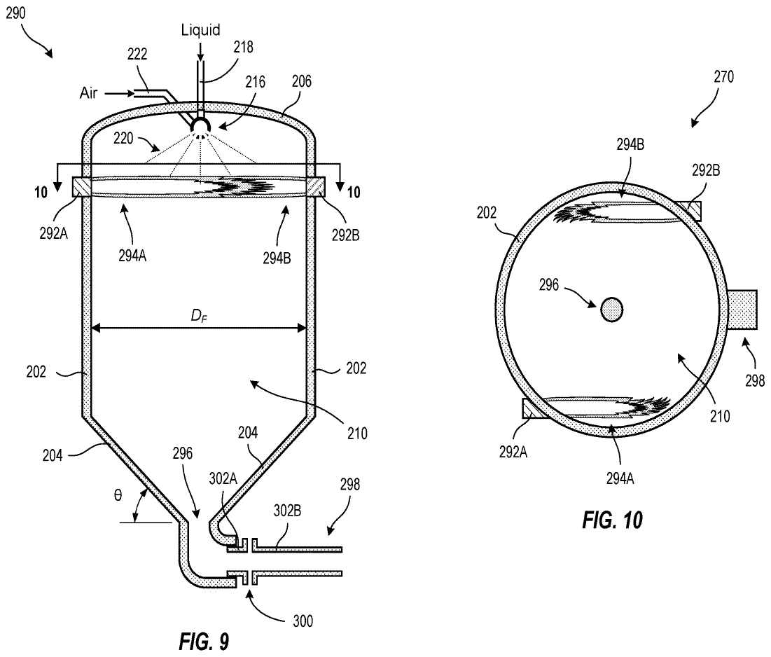

In an example, the hydrated aluminum salt solution 22 is sprayed in a fine atomized mist 32 (shown conceptually in FIG. 1). The mist 32 can be sprayed at a top portion of the calcination furnace 28. In an example, the hydrated aluminum salt solution 22 is sprayed substantially continuously into the calcination furnace 28. In an example, the hydrated aluminum salt solution 22 is sprayed directly into the flame of the calcination furnace 28 (as in shown in the example embodiments of the calcination furnaces 270 and 290 in FIGS. 7 and 9, below).

The hydrated aluminum salt solution 22 can be sprayed through a spray nozzle 34, such as an alumina atomizing spray nozzle. The hydrated aluminum salt solution 22 can be injected through the spray nozzle 34 using pressurized air. A venturi can be used to suck the hydrated aluminum salt solution 22 into the spray nozzle 34 or air pressure can be used to push the hydrated aluminum salt solution 22 into the spray nozzle 34. In an example, the hydrated aluminum salt solution 22 can be diluted with high-purity water before the spray roasting 26 to change the viscosity of the solution and to alter the alumina particle size produced by the spray roasting 26.

When the hydrated aluminum salt solution 22 is sprayed into the calcination furnace 28, heat energy in the calcination furnace 28 vaporizes the solvent of the hydrated aluminum salt solution 22, e.g., acid, such as HCl, and water, which results in an acid steam 36 that exits the calcination furnace 28. The heat energy also converts the remaining one or more hydrated aluminum salt compounds from the hydrated aluminum salt solution 22, such as PAC, to alumina to form the alumina powder 30. The acid steam 36 can be collected in a heat exchanger, e.g., to condense the acid steam 36, and the condensed acid steam can be recycled back into the process, for example by recycling the condensed acid steam to form a portion of the one or more acids 20 for the first reaction 18 such as by feeding the condensed acid steam into the first reaction vessel. The acid steam 36 can be collected in a series of at least one of one or more heat exchangers, one or more falling film absorbers, and one or more scrubbers. The heat exchangers or falling film absorbers, or both, can be made of graphite or tantalum. A scrubber can be made of one or more of Kynar, PP, and PE, depending on the temperature of the acid steam 36. The acid steam 36 can be connected to a venturi or cyclone to remove fine alumina dust from the acid steam 36 and to reduce the temperature of the acid steam 36. In an example, the acid steam 36 can be removed tangential to a round furnace 28, which can cause the hot gases in the calcination furnace 28 to swirl in the calcination furnace 28.

In an example, the calcination furnace 28 comprises a cylinder shape with a conical bottom, as shown in FIG. 1. The calcination furnace 28 can be lined with a high-temperature resistant refractory, such as a high-purity alumina refractory. For example, the calcination furnace 28 can be made of high-purity alumina brick with high purity alumina mortar or dry-stacked high purity alumina brick. In accordance with a specific embodiment, an inside surface of the calcination furnace 28 is made of alumina that is 99.2%, or greater, purity aluminum oxide refractory, in order to minimize or eliminate contamination of the resulting alumina powder 50. In more specific embodiments, the refractory of the calcination furnace 28 comprises alumina that is 99.2% purity or purer, or that is 99.6% purity or purer, or that is 99.8% purity or purer.

After being sprayed, such as through the spray nozzle 32, the hydrated aluminum salt solution 22 is heated to a temperature that is sufficiently high to drive off the liquid of the hydrated aluminum salt solution 22 (e.g., water and acid) and to calcine the hydrated aluminum salt from the solution 22 to alumina to form the alumina powder 30. For example, if a PAC solution is sprayed into the calcination furnace 28, the mist 32 of the PAC solution can be heated to a temperature of at least 450° C., such as to a temperature of from about 450° C. to about 1300° C., in order to convert the PAC to alumina. The temperature to which the hydrated aluminum salt solution mist 32 is heated can depend on the phase of alumina that is desired for the particular process. For example, if it is desired to provide predominantly alpha alumina, then the hydrated aluminum salt solution 22 can be heated to a temperature of at least 900° C., or of at least 1000° C., such as from about 900° C. to about 1300° C. or from about 1000° C. to about 1300° C. If lower temperatures are used, e.g., temperatures below about 1000° C. or about 1100° C., then the resulting alumina powder 30 can be a mixture of phases with a majority of the mixture being non-alpha phase. The predominant phase of the alumina powder 30 can be gamma, theta, kappa or other phases of alumina other than alpha alumina depending on the calcination temperature within the calcination furnace 28.

It has been found that the temperatures required to achieve a particular alumina phase, such as alpha alumina, is lower when using the spray roasting calcination furnace 28 described herein as compared to conventional temperatures required to convert hydrated alumina salt crystals, such as PAC crystals, which are not being spray roasted. For example, it has been found that a temperature of at least 1150° C., and in some cases as much as 1600° C. can be required for calcinating larger PAC crystals to alpha alumina. The lower required temperature in the spray roasting calcination furnace 28 can result in substantially lower energy costs for forming the alumina powder 30.

The calcination furnace 28 can be heated by combustion of fuel, such as natural gas, oil or propane, with one or more burners. There can be a temperature gradient in the calcination furnace 28, such as from the burner to the exhaust point 38. The air for the one or more combustion burners can be filtered. In an example, each of the one or more burners can be fed from about 5% to about 50% excess air. The calcination furnace 28 can also be heated by indirect heat, such as from a natural gas tube burner.

As seen in FIG. 1, the bottom of the calcination furnace 28 can be conical and can include a bottom hole or tube for removal of the alumina powder 30. The removal tube can be made of alumina. Alternatively, the bottom of the calcination furnace 28 can be flat with extra alumina powder 30 being left in the bottom of the furnace 28. As the alumina powder 30 flows out of the calcination furnace 28 via gravity, the alumina powder 30 remaining in the furnace 28 may then form a conical shape. The alumina powder 30 can be removed from the furnace through a tube in the bottom of the calcination furnace 28, such as an alumina or silicon nitride removal tube. The removal tube can be heated so that the alumina powder 30 reaches a higher calcination temperature. The alumina powder 30 can be removed continuously from the bottom of the calcination furnace 28. The alumina powder 30 can fill up a container as it comes out of the removal tube. Alumina powder 30 removed from the container can be replaced by gravity flow as more alumina powder 30 is produced. The alumina powder 30 can be removed from the furnace 28 continuously or semi continuously, such as with a rotary valve, slide gate, rabble rake, auger, or vibrating conveyor.

The calcination furnace 28 can be operated under slightly negative pressure so that the acidic steam 36, e.g., HCl fumes, will not escape through the bottom exit, but rather will exit the calcination furnace 28 through an exhaust 38. The calcination furnace 28 can be put under negative pressure by a blower that pulls air through a scrubber, such as from the exhaust 58. In an example, the alumina powder 50 can be in the form of hollow shells.

In an example, the spray roasting calcination 26 can be done in two different furnaces or stages. For example, the first phase can comprise spray roasting and calcination to partial alpha phase or non-alpha phase alumina powder, e.g., in the spray roasting calcination furnace 28 shown in FIG. 1, and the second calcination phase can comprise converting the partial alpha or non-alpha phase alumina powder to alpha phase alumina powder 30, e.g., in a conventional solids furnace. The partial alpha or non-alpha phase alumina powder can be washed between the two calcinations, for example with acid, or water, or both. In an example, the partial alpha or non-alpha phase alumina powder can be washed with one or more of: a rotary drum filter, filter press, or a pan filter, or both. In an example, the powder can be washed first with acid then with water to remove traces of the acid.

For a two-stage calcination, after being calcined to the partial alpha or non-alpha phase, the partial alpha or non-alpha phase alumina powder can be placed into a second furnace and further calcined to a temperature of at least about 1000° C., such as from about 1000° C. to about 1250° C., to convert the partial alpha or non-alpha phase alumina powder into alpha alumina powder. After washing, the partial alpha or non-alpha phase alumina powder can be mixed with water and sprayed into the second furnace. The steam and acid coming off the alumina powder in the second furnace can be condensed in a heat exchanger and be reused in the process. The calcination to alpha alumina can also be performed at higher temperatures, such as from about 1050° C. to about 1600° C., or from about 1250° C. to about 1600° C., to reduce impurities and to increase the loose density of the powder.

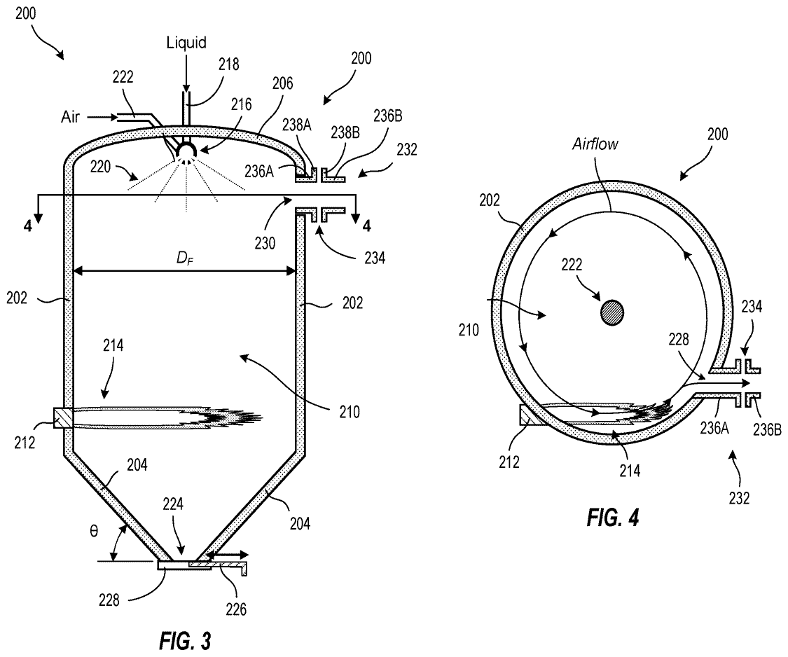

Further details of several example structures for the calcination furnace 28 are described with respect to the example embodiments of furnaces 200, 250, 270, and 290 described below with respect to FIGS. 3-10. As will be appreciated by those having skill in the art, any one of the furnaces 200, 250, 270, 290 of FIGS. 3-10 can be used as the calcination furnace 28 in the process 10 of FIG. 1. Similarly, those having skill in the art can design a furnace comprising a combination of features from one or more of the example furnaces 200, 250, 270, 290 described below to be used as the calcination furnace 28 in the process 10 of FIG. 1, without varying from the scope of the present disclosure.

The alumina powder 30 can optionally be further processed into one or more different processed alumina forms. As described in more detail with respect to FIG. 1, the processing can include one or more operations, in any desired order, including but not limited to one or more of: crushing; tumbling; washing; drying; milling; adding one or more binders, sintering aids, or other chemical or chemicals; pressing; sintering; classifying; and melting to provide an alumina product, such as a sapphire product 40.

In an example, further processing of the alumina powder 30 in the process 10 includes, at step 42, performing an initial processing of the alumina powder 30, such as by milling, crushing, or tumbling the alumina powder 30, to provide a processed alumina powder 44 having a desired size profile. For example, the alumina powder 30 can be wet or dry tumbled to break up lumps, such as by adding the alumina powder 30 to a rotating impeller, with or without water, to break up the lumps. In an example, the processed alumina powder 44 can have an average powder grain size of about 50 nanometers (nm) for partial alpha or non-alpha alumina and from about 200 nm to about 1000 nm for alpha alumina. In an example, the surface area of the processed alumina powder 44, as determined by Brunauer-Emmett-Teller (BET) theory, is from about 0.001 square meters per gram (m²/g) to about 15 m²/g. In an example, the processed alumina powder 44 can have a density of at least about 0.2 grams per milliliter (g/mL), such as at least about 0.5 g/mL, for example at least about 1 g/mL.

In an example, the initial processing 42 can also include separating impurities from the alumina powder 30, such as by using a magnet to remove impurities from the alumina powder 30, sieving the alumina powder 30 to remove the impurities, or running the alumina powder 30 through a fluid bed reactor to separate out particles and impurities. All further processing steps described below can be performed on either the alumina powder 30 directly after the spray roasting 26 as the starting material and/or on the processed alumina powder 44 (also referred to as “the alumina powder 30, 44”) as the starting material.

Next, processing of the alumina powder 30, 44 can include, at step 46, washing the alumina powder 30, 44 to provide a washed alumina powder 48, such as by applying a washing medium to the alumina powder 30, 44. In an example, the washing medium that is used for the washing 46 of the alumina powder 30, 44 is water (H₂O), an acid, or a combination thereof, such as a weak HCl acid solution. In some examples, the washing 46 of the alumina powder 30, 44 includes using a first washing medium, such as an acid, to wash the alumina powder 30, 44, followed by washing with a second medium, such as water, one or more times to remove traces of the first washing medium. In an example, the washing medium used during the washing 46 of the alumina powder 30, 44 has a high purity, such as high-purity water or high-purity acid. In an example, washing 46 of the alumina powder 30, 44 can be repeated multiple times, as desired, to remove any residue from the washed alumina powder 48. Washing 46 of the alumina powder 30, 44 can include washing the alumina powder 30, 44 with a weak acid, e.g., an acid that is from about 0.5 wt. % to about 5 wt. % HCl, followed by one or more steps of washing with water to provide the washed alumina powder 48. The alumina powder 30, 44 can be rinsed with other types of acid or just with water instead of the HCl and water. The washed alumina powder 48 can be separated from the one or more washing media by settling or mechanical separation, such as a centrifuge or vacuum filtration (e.g., a rotary drum filter, filter press, a disk filter, or rotary pan filter). In an example, a slurry of the washed alumina powder 48 can be formed before further processing, such as the spray drying described below.

Next, at step 50, the process 10 can include drying the washed alumina powder 48 to provide a dried alumina powder 52. In an example, the drying 50 of the washed alumina powder 48 includes exposing the washed alumina powder 48 to an elevated temperature to remove the washing medium (e.g., water or acid) from the washed alumina powder 48 by evaporation. For example, the washed alumina powder 48 can be placed in a drying furnace 54 that is heated to a temperature that is high enough to evaporate the washing medium but not so high so as to further convert the aluminum oxide of the washed alumina powder 48 to a different form. In an example, the drying furnace 54 can include a vacuum furnace, a convection oven, a spray dryer, a flash dryer or a microwave oven.

In the example shown in FIG. 1, the drying 50 of the washed alumina powder 48 can be performed by a spray drying process that is similar to the spray roasting 26 described above, albeit at different temperatures. For example, the drying furnace 54 can be a spray drier 54 and the washed alumina powder 48 can be sprayed into the spray drier 54 via a spray nozzle 56 that disperses the washed alumina powder 48 as a fine mist 58 into the interior of the spray drier 54. In an example, the washed alumina powder 48 can be mixed with a suspension medium, such as high-purity water, to form a slurry of the washed alumina powder 48 that is more easily able to be dispersed into the fine mist 58 within the spray drier 54. In an example, a pH adjustment medium can be added to the washed alumina powder 48 before or after forming the slurry so that the pH of the washed alumina powder 48 and/or the slurry will be at a specified pH. In some examples, the specified pH of the washed alumina powder 48 or the slurry is selected so that the slurry will have a specified viscosity, for example so that the slurry viscosity is conducive to spraying as in the spray drying 50 described herein. Examples of pH adjustment media include, but are not limited to, one or more of citric acid and an ammonia hydroxide solution. In an example, the pH of the washed alumina powder 48 is adjusted by first adding a first specified amount of citric acid, followed by adding a second specified amount of an ammonia hydroxide solution to achieve a specified pH for the washed alumina powder 48 before forming the slurry.

The interior of the spray drier 54 can be heated to a temperature that is sufficiently high to evaporate the washing medium and/or the suspension medium (e.g., water) from the solid alumina particles of the washed alumina powder 48. In an example, the spray drier 54 can be heated to a temperature of from about 400° C. to about 1350° C. The dispersal of the washed alumina powder 48 into the fine mist 58 allows for more direct heating of the water or other liquid media that may be present on the solid particles of the washed alumina powder 48 to more efficiently dry the solid alumina particles in order to provide the dried alumina powder 52. The vaporized liquid medium (e.g., water) can exit the spray drier 54 as a vapor 60 (e.g., in the form of water vapor).

Further details of several example structures for the spray drier 54 are described with respect to the example embodiments of furnaces 200, 250, 270, and 290 described below with respect to FIGS. 3-10. As will be appreciated by those having skill in the art, any one of the furnaces 200, 250, 270, 290 of FIGS. 3-10 can be used as the spray drier 54 during the spray drying 50 in the process 10 of FIG. 1. Similarly, those having skill in the art can design a spray drying furnace comprising a combination of features from one or more of the example furnaces 200, 250, 270, 290 described below to be used as the spray drier 54 in the process 10 of FIG. 1, without varying from the scope of the present disclosure.

The process 10 can also include, at step 62, milling, tumbling, or grinding (referred to simply as “the milling 62” for brevity) of one or more of the alumina powder 30, the processed alumina powder 44, or the dried alumina powder 52 (also referred to generically herein as “the alumina powder 30, 44, 52”) to provide a milled alumina powder 64. The milling 62 of the alumina powder 30, 44, 52 can reduce the average particle size of the alumina powder 30, 44, 52. In an example, after the milling 62, the milled alumina powder 64 has a reduced average particle size of from about 0.3 micron to about 3 micron. Examples of equipment that can be used for the milling 62 of the alumina powder 30, 44, 52 includes, but is not limited to, a jet mill, an attrition mill, a ball mill, or another type of milling equipment. In some examples, the milling 62 can include vibratory tumbling or tumbling in a barrel can be performed in addition to or in place of conventional milling with one of these milling devices. Barrel tumbling and/or vibratory tumbling can break up lumps of the alumina powder 30, 44, 52 and/or can reduce the size of some of the particles of the alumina powder 30, 44, 52. In some examples, tumbling media can be used, such as high-purity alumina, zirconia, or sapphire tumbling media, to enable or enhance the tumbling and/or milling.

In an example, after the milling 62, the milled alumina powder 64 can be sintered in a vacuum furnace to remove impurities from the milled alumina powder 64 and increase the loose pack density of the powder 64. The furnace temperature and vacuum can be varied to get specified results. In an example, a 0.07 Torr vacuum can be applied to a furnace heated to 450° C. to perform the vacuum sintering of the milled alumina powder 64. In general, higher temperatures and stronger vacuum improve removal of impurities from the milled alumina powder 64.

In an example, any one or more of the alumina powders described above—e.g., the alumina powder 30 directly after the spray roasting 26, the processed alumina powder 44, the washed alumina powder 48, the dried alumina powder 52, and the milled alumina powder 64 (collectively referred to generically herein as “the alumina powder 30, 44, 52, 64”) has an alumina purity of at least about 99.99% (abut 4N) alumina purity, such as at least about 99.997% alumina purity, such as at least about 99.999% (about 5N) alumina purity. In an example, any one or more of the alumina powders 30, 44, 52, 64 include impurities of less than 10 parts per million weight (ppmw) in all elements. In an example, any one or more of the alumina powders 30, 44, 48, 52, 64 comprises less than about 30 ppmw total metallic and alkyl impurities, for example less than about 5 ppmw total metallic and alkyl impurities.

In an example, any one or more of the alumina powders 30, 44, 52, 64 has a sodium (Na) content of less than 10 ppmw, such as less than about 5 ppmw Na, such as less than about 1 ppmw Na. In an example, any one or more of the alumina powders 30, 44, 52, 64 has an iron (Fe) content of less than 5 ppmw, such as less than about 3 ppmw Fe, such as less than about 1 ppmw Fe. In an example, any one or more of the alumina powders 30, 44, 52, 64 has a silicon (Si) content of less than 10 ppmw, such as less than about 5 ppmw Si, such as less than about 2 ppmw Si. In an example, any one or more of the alumina powders 30, 44, 52, 64 has a titanium (Ti) content of less than 1 ppmw, such as less than about 0.2 ppmw Ti. In an example, any one or more of the alumina powders 30, 44, 52, 64 has a magnesium (Mg) content of less than about 5 ppmw, such as less than about 2 ppmw Mg. In an example, any one or more of the alumina powders 30, 44, 52, 64 has a calcium (Ca) content of less than 5 ppmw, such as less than about 2 ppmw Ca. In an example, any one or more of the alumina powders 30, 44, 52, 64 has a potassium (K) content of less than about 5 ppmw. In an example, any one or more of the alumina powders 30, 44, 52, 64 has a copper (Cu) content of less than about 1 ppmw. In an example, any one or more of the alumina powders 30, 44, 52, 64 has a chromium (Cr) content of less than about 1 ppmw In an example, any one or more of the alumina powders 30, 44, 52, 64 comprises less than 5 ppmw combined for Fe, Na, and Si. In an example, any one or more of the alumina powders 30, 44, 52, 64 has less than 5 ppmw combined for Fe, Na, and Si, and 3 ppmw total for all other elements. In an example, any one or more of the alumina powders 30, 44, 52, 64 has less than 3 ppmw combined for Fe, Na, and Si and less than 1 ppmw total for all other elements.

The process 10 can also include, at step 66, compressing any one or more of the alumina powders 30, 44, 52, 64 into a compressed alumina powder 68 that has a higher density than the alumina powder 30, 44, 52, 64 before the compressing 66. The compressed alumina powder 68 can be in the form of any pressed shape, such as compressed pucks, pellets, or granules, and in particular for any shape that is conducive to eventual conversion into sapphire ingots. Examples of pressing methods that can used for the compressing 66 of the alumina powder 30, 44, 52, 64 include, but are not limited to, uniaxial pressing, hydraulic pressing, cold isostatic pressing (CIP), or hot isostatic pressing (HIP).

In an example, the density of the alumina powder 30, 44, 52, 64 before the compressing 66 can be from about 0.3 grams per cubic centimeter (g/cm³) to about 1.0 g/cm³, and the compressed alumina powder 68 after the compressing 66 can have a density of at least about 1.7 g/cm³, such as at least about 1.8 g/cm³, at least about 1.9 g/cm³, at least about 2 g/cm³, at least about 2.1 g/cm³, at least about 2.2 g/cm³, at least about 2.3 g/cm³, at least about 2.4 g/cm³, or at least about 2.5 g/cm³, such as from about 1.7 g/cm³ to about 2.3 g/cm³.

In example, one or more binders and/or one or more sintering aids can be added to the alumina powder 30, 44, 52, 64 before or during the compressing 66. If included, the one or more binders can bind the resulting compressed alumina powder 68 is bound together. Examples of binders that can be added to bind the compressed alumina powder 68 include, but are not limited to, one or more of: water, polyethylene glycol (PEG), and polyvinyl alcohol (PVA). In example included, the one or more sintering aids can enhance sintering of the compressed alumina powder 68 during a sintering step 70 (described below). Examples of sintering aids that can be added to the alumina powder 30, 44, 52, 64 before or during the compressing 66 includes, but are not limited to, one or more of: magnesia (MgO), yttria (Y₂O₃), yttrium aluminum garnet (YAG, e.g., Y₃Al₅O₁₂), or calcium oxide (quicklime, CaO). The compressing 66 of the alumina powder 30, 44, 52, 64 can include forming the resulting compressed alumina powder 68 into a specified shape including, but not limited to, a cylinder, a puck, a rectangular prism, and a hexagonal prism. In an example, the shape of the compressed alumina powder 68 is chosen for packing efficiency of the compressed alumina powder 68 in a crucible for sintering (described below). In other examples, the shape of the compressed alumina powder 68 is chosen as a final shape for a part made from the final alumina product, such as when making ceramic parts for a semiconductor etching chamber.

Next, the process 10 can include, at step 70, sintering the compressed alumina powder 68 to provide a sintered alumina 72. In an example, the sintering 70 can further increases the density of the alumina. For example, the compressed alumina powder 68 can have a density of from about 1.7 g/cm³ to about 2.3 g/cm³ and the sintering 70 of the compressed alumina powder 68 can result in the sintered alumina 72 having a density of at least about 3.0 g/cm³, such as at least about 3.1 g/cm³, at least about 3.2 g/cm³, at least about 3.3 g/cm³, at least about 3.4 g/cm³, at least about 3.5 g/cm³, at least about 3.6 g/cm³, at least about 3.7 g/cm³, at least about 3.8 g/cm³, at least about 3.9 g/cm³, or at least about 4 g/cm³, such as from about 3.2 g/cm³ to about 3.9 g/cm³.

In an example, the sintering 70 comprises exposing the compressed alumina powder 68 to a temperature of from about 1500° C. to about 2050° C., such as from about 1550° C. to about 1600° C. In some examples, the sintering 70 includes applying a vacuum to the compressed alumina powder 68 (e.g., generating a vacuum in the crucible in which the sintering 70 is performed). In an example, the atmosphere that the compressed alumina powder 68 is exposed to during the sintering 70 can comprise, for example, one or more of air, hydrogen (H₂) gas, carbon dioxide (CO₂) gas, an inert gas (such as nitrogen (N₂) or argon (Ar)).

The sintering 70 of the compressed alumina powder 68 can be performed in a furnace that is heated, for example, with electric resistance with elements made of silicon carbide (SiC), graphite, tungsten, or molybdenum disilicide (MoSi₂), or with natural gas burners. In an example, the sintering furnace can be insulated with aluminum oxide fiber board or bubble alumina. It has been surprisingly found that when the sintering 70 of the compressed alumina powder 68 is included in the process 10, the resulting sintered alumina 72 can have substantially reduced impurities compared to the unsintered alumina, such as the compressed alumina powder 68, or one of the alumina powders 30, 44, 48, 52, 64 before one or more of the other processing steps 42, 46, 50, 62, 66 described above.

The sintered alumina 72, or one of the earlier processed aluminas, such as the alumina powder 30 directly after the spray roasting 26, the washed alumina powder 48, the dried alumina powder 52, the milled alumina powder 64, or the compressed alumina powder 68 (referred to generically as “the alumina powder 30, 48, 52, 64, 68”) can be used as a feedstock for sapphire ingot growth. Therefore, in an example, the process 10 includes, at step 74, melting the alumina powder 30, 48, 52, 64, 68 and/or the sintered alumina 72 to convert the alumina into sapphire crackle, e.g., via the Verneuil process, to provide the sapphire 40. Examples of uses for the resulting sapphire 40 include, but are not limited to: as the cover glass for mobile electronic devices; as a semiconductor component, such as a semiconductor component for making advanced node semiconductors, for use in a semiconductor etching or deposition chamber; for making 3D NAND, or for making ring, lid, window chamber parts, chamber domes, chamber liners, deposition rings, electrostatic chucks, pins, gas distribution plates, gas showerheads, pedestal heaters, plating insulators, or vacuum break filters; and as sintered ceramic material for use in one or more processes including, but not limited to, chemical vapor deposition (CVD), physical vapor deposition (PVD), electrochemical plating (ECP), electrochemical deposition (ECD), and atomic layer deposition (ALD).

FIG. 2 is a flow diagram of another example process 100 for producing aluminum oxide, and in particular for producing high-purity aluminum oxide such as synthetic sapphire. The process 100 is very similar to the process 10 shown in FIG. 1, except that it includes additional processing steps that can be included to further purify the hydrated aluminum salt solution before calcination. Specifically, the process 100 of FIG. 2 includes steps of precipitating out the hydrated aluminum salt from an initial solution, separating the salt crystals from the mother liquor, followed by optional washing and redissolving of the aluminum salt crystals to form a second hydrated aluminum salt solution. The process 100 of FIG. 2 also includes some specific examples of operations that can be performed to process the resulting alumina powder into an alumina product, such as sapphire.

The initial steps of the process 100 can be the same or substantially the same as the process 10. For example, the process 100 can be for the conversion of an aluminum feedstock 102 to alumina. The aluminum feedstock 102 can be similar or identical to the aluminum feedstock 12 described above with respect to the process 10. The process 100 can begin at step 104, with optionally washing the aluminum feedstock 102 with a washing medium (such as one or more of water, an acid, a base, a soap or other surfactant, a solvent, or an alcohol), which can be similar or identical to the washing medium described above for the process 10, to provide a washed aluminum 106.

Next, the process 100 can include, at step 108, reacting aluminum (e.g., the aluminum feedstock 102 or the washed aluminum 106) with one or more acids 110 (which can be the similar or identical to the one or more acids 20 described above for the process 10) to provide a first hydrated aluminum salt solution 112. As with the reacting 18 in the process 10, the concentration of the one or more acids 110 can be modified, such as by diluting by adding water 114. As with the process 10, in examples wherein the acid 110 includes hydrochloric acid (HCl), the hydrated aluminum salt of the first hydrated aluminum salt solution 112 comprises hydrated aluminum chlorohydrate, also referred to as polyaluminum chloride (PAC), e.g., the group of aluminum salts having the general formula AlₙCl₍₃ₙ₋ₘ₎(OH)ₘ. Specific parameters for the reaction 108 in the process 100—such as reaction temperature, structure and materials of the reaction vessel, extent of the reaction, purity of reactants, amount of reactants added, acid concentration in the reaction vessel, and other processing such as mixing or filtering—can be similar or identical to that which is described above for the reaction 18 in the process 10.

After the reaction 108 to form the first hydrated aluminum salt solution 112, the process 100 can include precipitating at least a portion of the hydrated aluminum salt that is dissolved in the first hydrated aluminum salt solution 112 to produce a mixture 116 of precipitated hydrated aluminum salt crystals and a mother liquor. In an example, precipitation of solid hydrated aluminum salt crystals is accomplished by heating 118 the first hydrated aluminum salt solution 112, which can evaporate water and/or other liquids. Removal of water, gases, and/or other liquids from the first hydrated aluminum salt solution 112 causes the concentration of the hydrated aluminum salt dissolved in the solution 112 to increase so that the first hydrated aluminum salt solution 112 may eventually become saturated, causing solid hydrated aluminum salt crystals to precipitate out.

In an example, the first hydrated aluminum salt solution 112 can be heated 118 at a temperature of from about 100° C. to about 140° C. Some acids 110 can require a higher temperature during the heating 118 in order to evaporate a sufficient amount of water from the solution 112. In an example, the heating 118 of the first hydrated aluminum salt solution 112 can be for a time period of from about 8 hours to about 72 hours. The first hydrated aluminum salt solution 112 can be heated 118 until from about 70% to about 99.9% of the liquid from the first hydrated aluminum salt solution 112 has been evaporated, such as when about 0% to about 20% of the liquid remains. Alternatively, the majority of the liquid can be evaporated and then a small percentage of water, such as high-purity water, can be added to the solid salt to create mother liquor. The first hydrated aluminum salt solution 112 can be heated 118 in the same vessel in which the aluminum 102, 106 was reacted with the one or more acids 110 if any remaining aluminum is removed, or the heating 118 can be performed in a separate vessel.

In an example, the heating 118 to precipitate out the aluminum salt crystals into the mixture 116 of aluminum salt crystals and mother liquor can be performed in a heating vessel comprising materials that will not add contamination to the process, also referred to as a non-contaminating heating vessel or as non-contaminating material. In an example, the heating vessel can comprise at least one of a high-temperature plastic such as PTFE, FEP, PFA, PVDF, alumina; or other high temperature plastics or ceramics that can withstand the temperature of the heating 118 and chemical attack by the salts, liquid, and vapor present in the heating vessel. The heating vessel can also be made of another material that is coated with PTFE, FEP, PFA, PVDF, alumina, or another high-temperature plastic or ceramic that can withstand the temperature and chemicals of the heating vessel.

Examples of methods to heat 118 the first hydrated aluminum salt solution 112 in a heating vessel can include, but are not limited to, at least one of: heating in a furnace, heating with a heat exchanger coil, heating with an immersion heater, heating with a hot oil heater, heating with steam, heating with a PTFE or graphite heat exchanger in the first hydrated aluminum salt solution 112, heating by injecting high-purity steam with a boiler, or heating with external heat. The heating vessel can have a filter air inlet and a vent for the acidic steam. The heating vessel can comprise a draft so that the aluminum salt crystals and mother liquor mixture 116 can be easily removed from the heating vessel.

The heating 118 of the first hydrated aluminum salt solution 112 produces evaporated vapor 120, which in many examples of the process 100 will comprise water vapor and/or acid vapor. In an example, the process 100 can include, at step 122, condensing the vapor 120 in order to recover water and/or acid, such as for recycling back to the reaction 108. A blower can be used to withdraw the vapor 120, which can then be condensed 122 in a heat exchanger to provide a condensed liquid 124. Any uncondensed vapor can be processed by a scrubber, neutralized, and then vented to the atmosphere. The condensed liquid 124 can be recycled and reused in the process, for example by recycling the condensed liquid 124 back to the reaction 108 between the aluminum 102, 106 and the acid 110. The condensed liquid 124 can be purified before recycling. In an example, the condensed liquid 124 can be used to make lower quality alumina.

In an example, the heating 118 to provide the mixture 116 of the aluminum salt crystals and the mother liquor can be performed in a container or vessel under vacuum, e.g., with the pressure within the heating vessel being less than atmospheric pressure. The application of a vacuum to the heating vessel can increase the rate at which steam and acid vapor 120 are removed from the vessel, which, in turn, can increase the rate and extent of precipitation of aluminum salt crystals into the mixture 116 of the aluminum salt crystals and mother liquor. The application of the vacuum to the heating vessel has been found to speed up the rate of evaporation and lower the required reaction temperature.

In an example, the vacuum can be provided with a blower capable of applying a vacuum pressure to the vessel. In an example, a blower rated for at least about 5 inches of water (about 0.012 bar) can be used to provide the vacuum pressure. In an example, the vacuum pressure within the heating vessel (e.g., the pressure below atmospheric pressure) can be at least 0.005 bar vacuum, such as at least about 0.01 bar vacuum, for example at least about 0.015 bar vacuum, such as at least about 0.02 bar vacuum, at least about 0.03 bar vacuum, at least about 0.04 bar vacuum, at least about 0.05 bar vacuum, at least about 0.1 bar vacuum, at least about 0.15 bar vacuum, at least about 0.2 bar vacuum, or at least about 0.25 bar vacuum.

Alternative to, or in conjunction with, the heating 118, HCl gas, high-purity HCl acid solution, or another acid solution, such as H₂SO₄, can be injected into the first hydrated aluminum salt solution 112 in order to lower the solubility of the hydrated aluminum salt dissolved in the first hydrated aluminum salt solution 112 in order to cause the salt to precipitate. In an example, a 38% HCl solution having a high purity can be added to the first hydrated aluminum salt solution 112 in order to precipitate out aluminum salt crystals to provide the mixture of the solid hydrated aluminum salt crystals and the mother liquor.

Next, the process 100 can include, at step 126, separating the mixture 116 to provide separated mother liquor 128 and solid hydrated aluminum salt crystals 130. The separation 126 process can include, but is not limited to, settling, filtering, or centrifuging the hydrated aluminum salt crystals and mother liquor mixture 116. The separation 126 can be performed in one or more non-contaminating separation vessels, which can comprise one of the non-contaminating materials described above with respect to the reaction vessel and the heating vessel. The separation 126 can be done at room temperature or at any temperature up to the evaporation temperature of the process.

The mixture 116 of the hydrated aluminum salt crystals and mother liquor can be allowed to cool to room temperature before the separation 126. The mixture 116 of the hydrated aluminum salt crystals and mother liquor also can be slowly cooled to room temperature before separation 126. In an example, the mother liquor 128 and the hydrated aluminum salt crystals 130 can be separated 126 by draining the mother liquor 128 from the vessel holding the mixture 116, such as by opening a filtered valve, e.g., a valve with a plastic filter cloth or perforated plastic drain, and removing the mother liquor 128 by gravity drainage from the vessel.

In an example, the separation vessel can comprise a container, such as a high-temperature, acid-resistant plastic container, comprising an acid-resistant filter, such as a filter cloth, a plastic filter, a filter bag, or a plurality of holes in the container, such as in the bottom and sides of the container, that can allow the mother liquor 128 to drain out of the container and away from the hydrated aluminum salt crystals 130. Alternatively, the separation 126 of the mother liquor 128 and the hydrated aluminum salt crystals 130 can be accomplished using one or more of: centrifugation, filtering (such as the drainage filter described above or a filter press-type device), vacuum assisted drainage, or other mechanical separation methods. The separated mother liquor 128 can be used to make a lower purity alumina, as is known in the art.

In an example, after the separation 126, the separated hydrated aluminum salt crystals 130 can optionally be washed with a washing medium (not shown in FIG. 2). In an example, the washing medium can comprise at least one of a high-purity acid (such as HCl), high-purity acetone or another solvent, a high-purity solution of the hydrated aluminum salt (e.g., if the crystals 130 are polyaluminum chloride crystals, then a polyaluminum chloride solution can be used as the washing medium), and high-purity water. In an example, an acid washing liquid (e.g., high-purity HCl) is used with a concentration that is sufficiently high so that a substantial portion of the hydrated aluminum salt crystals 130 do not dissolve back into solution. The washing of the hydrated aluminum salt crystals 130 can also be sufficiently rapid so that a substantial portion of the hydrated aluminum salt crystals 130 do not dissolve. The washing medium can be purified and reused in the process. The hydrated aluminum salt crystals 130 can optionally be milled, ground, or tumbled so that the crystals 130 can have a smaller and/or more uniform size for later in the process 100.

Next, after separating the hydrated aluminum salt crystals 130 from the mother liquor 128 (and after any optional washing of the hydrated aluminum salt crystals 130), the process 100 can include, at step 132, dissolving the hydrated aluminum salt crystals 130 in a solvent, such as water 134, to form a second hydrated aluminum salt solution 136. In an example, the water 134 comprises high-purity water 134 so that the resulting second hydrated aluminum salt solution 136 will also be high-purity, e.g., with less than a specified amount of one or more impurities (as defined and discussed above). If the one or more acids 110 used during the reacting 108 is HCl such that the first hydrated aluminum salt solution 112 comprises a PAC solution, then the second hydrated aluminum salt solution 136 will also comprise PAC dissolved in the water 134. In an example, the dissolving 132 of the separated hydrated aluminum salt crystals 130 to form the second hydrated aluminum salt solution 136 can include heating the water 134 to a specified temperature to increase the dissolution rate of the hydrated aluminum salt crystals 130.

After dissolving 132 the hydrated aluminum salt crystals 130 to form the second hydrated aluminum salt solution 136, the process 100 can include, at step 138, calcining the one or more hydrated aluminum salt compounds in the second hydrated aluminum salt solution 136 to convert them to alumina. As shown in FIG. 2, the calcining 138 of the one or more hydrated salt compounds can comprise spraying the second hydrated aluminum salt solution 136 into a heated environment such as a calcination furnace 140, similar to the spray roasting 26 of the hydrated aluminum salt solution 22 in the process 10 of FIG. 1, such that the calcination 138 will also be referred to as “spray roasting 138.” The spray roasting 138 can be similar or identical to the spray roasting 26 described above with respect to the process 10. For example, the spray roasting 138 can comprise spraying the second hydrated aluminum salt solution 136 into the calcination furnace 140, which is heated to a sufficiently high temperature to convert the one or more hydrated aluminum salt compounds to an alumina powder 142. The calcination furnace 140 can include a spray nozzle 144 configured to disperse the second hydrated aluminum salt solution 136 as a fine mist 146 into the interior of the calcination furnace 140, such as directly into the flame of the calcination furnace 140. The calcination furnace 140 and the spray nozzle 144 used in the process 100 can be similar or identical to the calcination furnace 28 and the spray nozzle 34 described above with respect to the process 10.

During the spray roasting 138, heat energy in the calcination furnace 140 vaporizes the solvent of the second hydrated aluminum salt solution 136, e.g., acid, such as HCl, and water, which results in an acid steam 148 that exits the calcination furnace 140. The heat energy also converts the remaining one or more hydrated aluminum salt compounds from the second hydrated aluminum salt solution 136, such as PAC, to alumina to form the alumina powder 142. The acid steam 148 can be collected and used in another part of the process 100, e.g., the acid steam 148 can be condensed in a heat exchanger to form an acid solution that can be used to form part of the acid used for one or more steps of the process 100.

Specific parameters for the spray roasting 138 of the second hydrated aluminum salt solution 136 in the process 100—such as the calcination temperature, heating source of the calcination furnace 140, structure and materials of the calcination furnace 140 and the spray nozzle 144, etc.—can be similar or identical to that which is described above for the spray roasting 26 in the process 10.

Like the process 10, the alumina powder 142 that results after the spray roasting 138 can be further processed to form a processed alumina, such as a sapphire product 150. For example, the processing of the alumina powder 142 can include, at step 152, performing an initial processing of the alumina powder 142 to provide a processed alumina powder 154. In an example, the initial processing 152 in the process 100 can be similar or identical to the initial processing 42 in the process 10—e.g., including one or more of milling, crushing, or tumbling. In an example, the processed alumina powder 154 can have an average powder grain size of about 50 nanometers (nm) for partial alpha or non-alpha alumina and from about 500 nm to about 1000 nm for alpha alumina. In an example, the surface area of the processed alumina powder 154, as determined by Brunauer-Emmett-Teller (BET) theory, is from about 6 square meters per gram (m²/g) to about 15 m²/g. In an example, the processed alumina powder 154 can have a density of at least about 0.2 grams per milliliter (g/mL), such as at least about 0.5 g/mL, for example at least about 1 g/mL. All further processing steps described below can be performed on either the alumina powder 142 directly after the spray roasting 138 as the starting material and/or on the processed alumina powder 154 (also referred to generically as “the alumina powder 142, 154”) as the starting material.

Next, processing of the alumina powder 142, 154 can include, at step 156, washing the alumina powder 142, 154 to provide a washed alumina powder 158. In an example, the washing 156 of the alumina powder 142, 154 can be similar or identical to the washing 46 described above for the process 10—e.g., the washing 156 can include applying a washing medium (such as water, an acid, or a combination thereof) to the alumina powder 142, 154. In an example, the washing medium used during the washing 156 has a high purity, such as high-purity water or high-purity acid. In an example, the washing 156 of the alumina powder 142, 154 can be repeated multiple times, as desired, to remove any residue from the washed alumina powder 158. The washing 156 of the alumina powder 142, 154 can include washing the alumina powder 142, 154 with a weak acid, e.g., an acid that is from about 0.5 wt. % to about 5 wt. % HCl, followed by one or more steps of washing with water to provide the washed alumina powder 158. The alumina powder 142, 154 can be rinsed with other types of acid or just with water instead of the HCl and water. The washed alumina powder 158 can be separated from the one or more washing media by settling or mechanical separation, such as a centrifuge or vacuum filtration (e.g., a rotary drum filter, filter press, a disk filter, or rotary pan filter).

Next, at step 160, the process 100 can include drying the washed alumina powder 158 to provide a dried alumina powder 162. In an example, the drying 160 comprises placing the washed alumina powder 158 in a furnace to remove excess water. In an example, the washed alumina powder 158 is dried in one or more trays comprising one or more of PTFE, PFA, PVDF, aluminum oxide, or aluminum. In an example, a vacuum furnace, a convection oven, a spray dryer, a flash dryer or a microwave oven can be used to dry the washed alumina powder 158 and to help remove impurities therefrom. In an example, the drying 160 of the washed alumina powder 158 can be via a spray drying method that is similar or identical to the spray drying 50 described above with respect to the process 10.

The process 100 can also include, at step 164, milling, tumbling, or grinding (referred to simply as “the milling 164” for brevity) of one or more of the alumina powder 142, the processed alumina powder 154, or the dried alumina powder 162 (also referred to generically hereinafter as “the alumina powder 142, 154, 162”) to provide a milled alumina powder 166. In an example, the milling 164 is similar or identical to the milling 62 described above with respect to the process 10—e.g., the milling 164 can reduce the average particle size of the alumina powder 142, 154, 162, so that the milled alumina powder 166 has a reduced average particle size of from about 0.3 micron to about 3 micron.

In an example, any one or more of the alumina powders described above—e.g., the alumina powder 142 directly after the spray roasting 138, the processed alumina powder 154, the washed alumina powder 158, the dried alumina powder 162, or the milled alumina powder 166 (referred to generically hereinafter as “the alumina powder 142, 154, 162, 166”) has a alumina purity of at least about 99.99% (abut 4N) alumina purity, such as at least about 99.997% alumina purity, such as at least about 99.999% (about 5N) alumina purity.

In an example, any one or more of the alumina powders 142, 154, 162, 166 include impurities of less than 10 parts per million weight (ppmw) in all elements. In an example, any one or more of the alumina powders 142, 154, 162, 166 comprises less than about 30 ppmw total metallic and alkyl impurities, for example less than about 5 ppmw total metallic and alkyl impurities. In an example, any one or more of the alumina powders 142, 154, 162, 166 has a sodium (Na) content of less than 10 ppmw, such as less than about 5 ppmw Na, such as less than about 1 ppmw Na. In an example, any one or more of the alumina powders 142, 154, 162, 166 has an iron (Fe) content of less than 5 ppmw, such as less than about 3 ppmw Fe, such as less than about 1 ppmw Fe. In an example, any one or more of the alumina powders 142, 154, 162, 166 has a silicon (Si) content of less than 10 ppmw, such as less than about 5 ppmw Si, such as less than about 2 ppmw Si. In an example, any one or more of the alumina powders 142, 154, 162, 166 has a titanium (Ti) content of less than 1 ppmw, such as less than about 0.2 ppmw Ti. In an example, any one or more of the alumina powders 142, 154, 162, 166 has a magnesium (Mg) content of less than about 5 ppmw, such as less than about 2 ppmw Mg. In an example, any one or more of the alumina powders 142, 154, 162, 166 has a calcium (Ca) content of less than 5 ppmw, such as less than about 2 ppmw Ca. In an example, any one or more of the alumina powders 142, 154, 162, 166 has a potassium (K) content of less than about 5 ppmw. In an example, any one or more of the alumina powders 142, 154, 162, 166 has a copper (Cu) content of less than about 1 ppmw. In an example, any one or more of the alumina powders 142, 154, 162, 166 has a chromium (Cr) content of less than about 1 ppmw In an example, any one or more of the alumina powders 142, 154, 162, 166 comprises less than 5 ppmw combined for Fe, Na, and Si. In an example, any one or more of the alumina powders 142, 154, 162, 166 has less than 5 ppmw combined for Fe, Na, and Si, and 3 ppmw total for all other elements. In an example, any one or more of the alumina powders 142, 154, 162, 166 has less than 3 ppmw combined for Fe, Na, and Si and less than 1 ppmw total for all other elements.

The process 100 can also include, at step 168, compressing any one or more of the alumina powders 142, 154, 162, 166 into a compressed alumina powder 170 that has a higher density than the alumina powder 142, 154, 162, 166 before the compressing 168. In an example, the compressing 168 can be similar or identical to the compressing 66 described above with respect to the process 10. In an example, the density of the alumina powder 142, 154, 162, 166 before the compressing 168 can be from about 0.3 grams per cubic centimeter (g/cm³) to about 1.0 g/cm³, and the compressed alumina powder 170 after the compressing 168 can have a density of at least about 1.7 g/cm³, such as at least about 1.8 g/cm³, at least about 1.9 g/cm³, at least about 2 g/cm³, at least about 2.1 g/cm³, at least about 2.2 g/cm³, at least about 2.3 g/cm³, at least about 2.4 g/cm³, or at least about 2.5 g/cm³, such as from about 1.7 g/cm³ to about 2.3 g/cm³.

Next, the process 100 can include, at step 172, sintering the compressed alumina powder 170 to provide a sintered alumina 174. In an example, the sintering 172 can be similar or identical to the sintering 70 in the process 10. In an example, the compressed alumina powder 170 (i.e., before the sintering 172) can have a density of from about 1.7 g/cm³ to about 2.3 g/cm³ and the sintering 172 of the compressed alumina powder 170 can result in the sintered alumina 174 having a density of at least about 3.0 g/cm³, such as at least about 3.1 g/cm³, at least about 3.2 g/cm³, at least about 3.3 g/cm³, at least about 3.4 g/cm³, at least about 3.5 g/cm³, at least about 3.6 g/cm³, at least about 3.7 g/cm³, at least about 3.8 g/cm³, at least about 3.9 g/cm³, or at least about 4 g/cm³, such as from about 3.2 g/cm³ to about 3.9 g/cm³.

The sintered alumina 174 (or earlier processed alumina, such as the alumina powder 142 directly after the spray roasting 138, the washed alumina powder 158, the dried alumina powder 162, the milled alumina powder 166, or the compressed alumina powder 170, generically referred to hereinafter as “the alumina powder 142, 154, 162, 166, 170”) can be used as a feedstock for sapphire ingot growth. In an example, the process 100 includes, at step 176, melting the alumina powder 142, 154, 162, 166, 170 and/or the sintered alumina 174 to convert the alumina into sapphire crackle, e.g., via the Verneuil process, to provide the sapphire 150. In an example, the resulting sapphire 150 can be used, for example, as for the cover glass for mobile electronic devices.

### Furnace for Spray Roasting or Spray Drying

FIGS. 3-10 show several examples of furnaces 200, 250, 270, and 290 that the inventors have developed for performing the challenging applications of high-temperature calcination or high-temperature powder drying. For example, each of the furnaces 200, 250, 270, 290 could be used as the calcination furnace 28 or 140 in the step of spray roasting 26 and 138 in the processes 10 and 100, respectively. Or each furnace 200, 250, 270, 290 could be used as the spray drier 54 in the step of spray drying 50 in the process 10. In other words, the furnaces 200, 250, 270, 290 have been found to be particularly useful in a process for producing high-purity alumina, as in processes 10 and 100. The example furnaces include several features that the inventors have found are particular conducive to these types of applications, which are described in more detail below.

It will be appreciated, however, that the furnaces 200, 250, 270, 290 are not limited to spray roasting a solution comprising a hydrated aluminum salt compound, including, but not limited to a solution comprising an aluminum chloride, such as a PAC solution, an aluminum nitride, or an aluminum sulfide in order to make high-purity alumina or spray drying an alumina powder slurry. Those having skill in the art will appreciate that each furnace 200, 250, 270, 290 can be used for calcining or spray drying other materials, including, but not limited to, other high purity ceramic materials such as one or more ceramic materials formed by the reaction of one or more acids (such as HCl) with a metal including, but not limited to, iron (Fe, e.g. to form iron III oxide (Fe₂O₃)), chromium (Cr), magnesium (Mg), manganese (Mn), zinc (Zn), beryllium (Be), calcium (Ca), and strontium (Sr).

As can be seen in FIGS. 3-10, all of the furnaces 200, 250, 270, and 290 share many common structures (such as the one or more furnace walls 202, 204, 206, described in more detail below). For any structure that is common to all of the furnaces 200, 250, 260, 270, the same reference number is used for all of FIGS. 3-10. Those having skill in the art will appreciate that just because a particular structure uses the same reference number for more than one of the furnaces 200, 250, 270, and 290 does not mean that the structure in question has to be exactly identical and will understand that variations or additions in structure may be used depending on the specific overall structure of the furnace 200, 250, 270, 290.

Turning to FIGS. 3 and 4, a first example embodiment of a furnace 200 is shown. The furnace 200 can be used for spray roasting or for spray drying. The furnace 200 comprises one or more furnace walls 202, 204, 206 that encloses a furnace interior 210. In the example best seen in FIG. 3, the furnace 200 includes one or more side walls 202 that laterally surround the furnace interior 210, one or more bottom walls 204 that are positioned vertically below the furnace interior 210, and one or more top walls 206 that are positioned vertically above the furnace interior 210.

In the example furnace 200 shown in FIGS. 3 and 4, the furnace 200 includes a cylindrical or substantially cylindrical side wall 202, a frustoconical bottom wall 204 that is coupled to and is angled inwardly from a vertical bottom end of the cylindrical side wall 202 to vertically cover the bottom of the furnace interior 210, and a domed or rounded top wall 206 that is coupled to a vertical top end of the cylindrical side wall 202 and that vertically covers the top of the furnace interior 210.

The size of the furnace 200 can be selected for the application for which it is designed. For example, the largest interior lateral width of the one or more side walls 202 (e.g., an inner diameter DF for the cylindrical side wall 202 shown in FIGS. 3 and 4) can be an important parameter for calcination to form a product powder (such as the alumina powder 30, 142 in the processes 10, 100) or for spray drying a product powder (such as the washed alumina powder 48 to provide the dried alumina powder 52 in the process 10). In an example, the inner diameter DF of the cylindrical side wall 202 (i.e., the diameter DF of the furnace interior 210) is from about 1 foot (about 30.5 centimeters (cm)) to about 20 feet (about 600 cm), such as from about 3 feet (about 90 cm) to about 12 feet (about 365 cm).

In an example, the one or more furnace walls 202, 204, 206 of the furnace 200 are made from a refractory material that can withstand the high temperatures of the spray roasting or the spray drying that is to be carried out in the furnace 200. An example of a refractory material that can be used to form each of the one or more furnace walls 202, 204, 206 include, but are not limited to, high purity alumina refractory such that the material of the refractory itself will not contaminate the alumina powder in the furnace 200. The temperature that the refractory material of the one or more walls 202, 204, 206 must withstand will depend on the application for which the furnace 200 is being used. If the furnace 200 is being used to calcine a hydrated aluminum salt compound to form aluminum oxide can require temperatures of at least about 450° C. to about 900° C. if partial alpha or non-alpha alumina is the desired product and to higher than 900° C. (e.g., 950° C. or higher, for example 1000° C. or higher, such as 1300° C. or higher, 1350° C. or higher, or 1600° C. or higher) if alpha phase alumina is desired. Even if the furnace 200 is being used for spray drying, temperatures of 400° C. or higher (e.g., 500° C. or higher, such as 750° C. or higher) can be necessary to ensure vaporization of a sufficient amount of moisture and other volatile compounds from the powder. These high temperatures can lead to a higher likelihood of impurities being incorporated into the product powder, such as due to diffusion into or reaction with the powder material. However, the furnace walls 202, 204, 206 can be exposed to lower temperatures if desired, for example so that organic binders or other chemical additives in the refractory material are not burned out during operation of the furnace 200.

In an example, one or more of the furnace walls 202, 204, 206 are made from refractor bricks that are shaped and stacked or otherwise arranged to form the desired three-dimensional configuration for that particular furnace wall 202, 204, 206. For conventional furnaces made from refractory bricks, mortar has been used to couple the bricks together and form the wall structures. However, mortar can be problematic for the high-temperature and high-purity applications described herein (e.g., high-temperature calcination or spray drying to form a high-purity alumina powder) because even the highest purity mortars that are commercially available can have contaminant levels that will pass to the liquid, solution, mixture, or slurry or the product powder within the furnace interior 210. Therefore, in an example, refractory bricks that form at least the portion of one or more of the furnace walls 202, 204, 206 (e.g., the portion of the walls 202, 204, 206 that face the furnace interior 210) are formed by dry stacking refractory bricks with no mortar (although mortar may be used to form other parts of the furnace 200, as discussed below). In other examples (such as in processes wherein the furnace 200 is not being used to form the high-purity alumina described herein), some high-purity mortar can be used to secure the refractory bricks of one or more of the furnace walls 202, 204, 206. An example of a high-purity mortar that can be used for coupling refractory bricks, either in one or more of the furnace walls 202, 204, 206 or in some other structure of the furnace 200, includes, but is not limited to, the mortar sold under the trade name RESITECT by RHI Magnesita GmbH, Vienna, Austria.

In some examples, one or more of the furnace walls 202, 204, 206 can be formed with two or more layers, such as a first, or inner layer formed from refractory bricks (such as the dry stacked, high-purity alumina bricks described above) that faces the furnace interior 210, and one or more second or outer layers that can be formed from other materials, such as lower purity refractory (e.g., lower purity refractory that might have more mechanical strength or better mechanical integrity during the heating and cooling of the furnace 200) or a metal skin or casing, that faces outward (i.e., away from the furnace interior 210). In an example, the one or more outer layers can comprise one or more of: lower purity refractory bricks (e.g., lower purity alumina refractor, or other refractory materials); a castable refractory material that is used to form the desired shape for the outer layer; or a metal, such as aluminum or steel (e.g., with an anticorrosion coating), that clads or coats outside surfaces of the one or more furnace walls 202, 204, 206, which can provide additional support to the one or more furnace walls 202, 204, 206.

In an example, an opening can be provided in the one or more furnace walls 202, 204, 206 to provide access to the furnace interior 210. For example, an access opening can be included in the side wall 202 or one of the other walls 204, 206 so that maintenance can be performed inside the furnace interior 210 (e.g., during a maintenance shutdown of the furnace 200). In another example, a pressure relief port can be provided in one or more of the furnace walls 202, 204, 206 that can be opened to release pressure from the furnace interior 210. In an example, the opening (whether a maintenance access opening or a pressure relief port, or both) can be formed in one or more of the furnace walls 202, 204, 206 (e.g., by leaving out refractory bricks for that portion of the wall 202, 204, 206), and then the opening can be bricked over with refractory bricks (e.g., the same material refractory bricks that are used to form the interior portion of the wall 202, 204, 206 that the opening is through) and/or another structure such as a refractory board that is placed over the opening. The size of the opening can depend on its purpose. For example, if the opening is to be a pressure relief opening or an opening or viewing the furnace interior 210, then the opening can have a relatively small size, such as a circular hole with a diameter of from about 2 inches (about 50 millimeters (mm)) to about 12 inches (about 300 mm), such as from about 4 inches (about 100 mm) to about 6 inches (about 150 mm).

In some examples, interior surfaces of the one or more furnace walls 202, 204, 206 can become coated with material, such as dried liquid, solution, mixture, or slurry or product powder that has fused or is otherwise sticking to one or more inner surfaces of the walls 202, 204, 206, or combustion ash, or some other material that is included in the process in which the furnace 200 is being used. In addition, for some materials that form the liquid, solution, mixture, or slurry that is sprayed into the furnace 200, impurities or other non-desirable compounds can diffuse out of the material coated on the one or more inner surfaces or from the bulk of the refractory material into the material being sprayed into the furnace interior. For example, the inventors have found that during long term spray roasting or spray drying in the furnace 200 for the production of high-purity alumina, sodium (Na), calcium (Ca), and other impurities can buildup on the inner surface of the one or more furnace walls 202, 204, 206 or in the bulk of the refractory material. Therefore, in an example, the process that uses the furnace 200 (which can be any of the processes 10, 100, or 300 described herein or any other process for which the furnace 200 can be used), can include a step of maintaining one or more furnace walls 202, 204, 206, such as to remove impurities that may have built up on the inner surfaces or bulk of the refractory material during normal operation of the furnace 200. In an example, the step of maintaining the one or more inner surfaces and/or the bulk of the refractory of the one or more furnace walls 202, 204, 206 can include chemical treatment of one or more of the furnace walls 202, 204, 206 to remove impurities, for example during a maintenance shutdown. The chemical treatment can include applying acid, polyaluminum chloride (PAC), or another chemical treatment liquid or solution to one or more inner surfaces of the furnace walls 202, 204, 206 (also referred to as the “inner wall surface”) so that the chemical treatment liquid or solution is in contact with the inner wall surface for specified treatment period. In some examples, the chemical treatment liquid or solution can react with material that is built up on the inner wall surface so that the buildup can become unattached from the inner wall surface. In other examples, which can be in place of or in addition to the removal of buildup material, the contact between the chemical treatment liquid or solution and the inner wall surface can allow impurities to leach from the refractory material of the furnace wall 202, 204, 206. Examples of specific chemical treatment solutions that are useful for leaching typical impurities in a high-purity alumina powder process include, but are not limited to, acids (and in particular strong acids such as hydrochloric acid, sulfuric acid, or nitric acid), or a hydrated aluminum salt solution such as PAC.

The specified treatment period for the contact between the inner wall surface and the chemical treatment liquid or solution can depend on the specific material to be removed as well as the desired purity level for the product powder coming from the furnace 200. In examples wherein the chemical treatment is configured to leach impurities (in particular to leach sodium (Na) and calcium (Ca) impurities) from the refractory of one or more furnace walls 202, 204, 206 to ensure production of high-purity alumina, the specified treatment period can be anywhere from about six (6) hours to about 150 days, such as from about 1 day to about 100 days, for example from about 14 days to about 90 days, such as at least about 1 day, at least about 2 days, at least about 3 days, at least about 4 days, at least about 5 days, at least about 7 days, at least about 10 days, at least about 14 days, at least about 15 days, at least about 17 days, at least about 20 days, at least about 21 days, at least about 24 days, at least about 25 days, or at least about 28 days, at least about 30 days, at least about 35 days, at least about 40 days, at least about 42 days, at least about 45 days, at least about 49 days, at least about 50 days, at least about 55 days, at least about 56 days, at least about 60 days, at least about 63 days, at least about 65 days, at least about 70 days, at least about 75 days, at least about 77 days, at least about 80 days, at least about 84 days, at least about 85 days, at least about 90 days, or more. The chemical treatment liquid or solution can also be heated to a treatment temperature to increase kinetics of leaching from out of the refractory material and into the chemical treatment liquid or solution and to increase the dissolution capacity of the target impurities into the chemical treatment liquid or solution. In an example, the chemical treatment liquid or solution can be heated to a treatment temperature of at least about 35° C., for example at least about 38° C., such as at least about 40° C., at least about 45° C. at least about 50° C., at least about 55° C., at least about 60° C., at least about 65° C., at least about 70° C., at least about 75° C., at least about 80° C., at least about 85° C., at least about 90° C., at least about 95° C., at least about 100° C., at least about 105° C., at least about 110° C., at least about 115° C., or at least about 120° C. However, as will appreciated by those having skill in the art, the exact treatment temperature that can be used will depend on the specific chemical treatment liquid or solution used. For example, if hydrochloric acid is used, it can only be heated to a maximum temperature of about 900-1200° C. (depending on the HCl concentration of the solution) before the water of the solution will start boiling. If PAC is used, it may be possible to reach a treatment temperature as high as about 120° C. or higher (again depending on the concentration).

Returning to the structures and operation of the furnace 200, the temperature of the air inside the furnace interior 210 is controlled primarily by a heating device. In the example shown in FIGS. 3 and 4, the heating device for the furnace 200 comprises one or more combustion burners 212 that generates a flame 214, which in turn heats the air within the furnace interior 210 to an elevated temperature. In an example, shown in FIGS. 3 and 4, the burner 212 is configured so that the flame 214 is directed into the furnace interior 210 to directly heat the air within. In an example, the burner 212 is coupled to one of the walls of the furnace 200, such as onto the side wall 202 as is best seen in FIG. 3.

As will be appreciated, the flame 214 not only heats the furnace interior 210, but it also creates a force as the combustion reaction proceeds, which creates a localized flow of the gases within the furnace interior 210. Therefore, the burner 212 can be positioned so that a desired flow pattern of gases within the furnace interior 210 can be achieved. For example, as is best seen in FIG. 4, in an example the burner 212 can positioned relative to the side wall 202 so that the flame 214 will be off-center relative to a lateral center-line through the furnace 200 (e.g., with the flame 214 being below the horizontal center line in, as is seen in the orientation shown in FIG. 4). The off-center flame 214 can act to create circulating air flow generally around the inner circumference of the furnace interior 210, which can help further mix the liquid, solution, mixture, or slurry that is sprayed into the furnace 200 with the air in the furnace interior 210. In an example, the burner 212 can be positioned and oriented so that the flame 214 will not only be off center, but so that the flame 214 will be located proximate to the interior side of the side wall 202. In some examples, the burner 212 is positioned and oriented so that the direction of the flame 214 is generally or substantially tangential to the circumference of the inner surface of the side wall 202, which can result in a rotation of the gases and entrained liquid, solution, mixture, or slurry and/or product powder within the furnace interior 210, similar to a whirlwind rotation (shown conceptually in FIG. 4 by the arrowed flow path labeled “Airflow”). The whirlwind-like rotation of gases and the liquid, solution, mixture, or slurry and/or the product powder can more effectively mix the heated gases and the liquid, solution, mixture, or slurry or powder and more effectively calcine or dry the compounds in question.

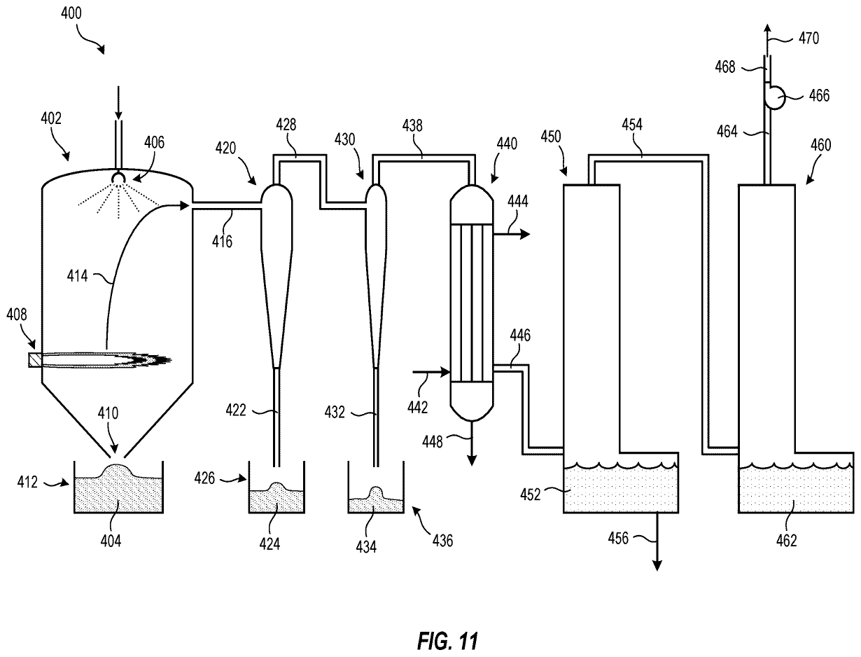

While the localized gas flow due to the force of the flame 214 is useful in generating the circulating and potentially whirlwind-like gas flow described above, if the velocity of the gases in the localized flow (also referred to herein as “flame velocity”) is too high, it can create other issues. For example, when the burner 212 is located at or proximate to the vertical bottom end of the furnace interior 210, as in the embodiment of the furnace 200\ shown in FIG. 3, and if the flame velocity is above a certain speed, then instead of creating a desired whirlwind circulation, the high-speed flame 214 might instead blow the product powder out of the powder exit opening 224 before the product powder has been fully processed (e.g., before the oxidation reaction has completed when the furnace 200 is being used for calcining such that the desired product may not have been formed, or before a desired moisture content has been reached if the furnace 200 is being used for spray drying the product powder). In other words, if the flame velocity is too high, then the flame 214 might force the powder out through the powder exit opening 224 before the powder has achieved a desired retention time within the furnace interior 210. In other examples wherein the flame velocity is too high, the force of the flame 214 can actually blow the powder out of the flue gas exit opening 230 (described below), such that some of the product powder is blown out through the flue gas chimney 232 (also described below) instead of being collected out of the powder exit opening 224. In such a situation, additional powder capturing processing steps may need to be employed beyond the processing, for example, the is described below with respect to the process 400 of FIG. 11. Therefore, in an example, the burner 212 is configured so that the flame 214 has a low to medium flame velocity, for example from at least about 15 meters per second (m/s), such as at least about 20 m/s, for example at least about 24.2 m/s, although the specific flame velocity that is chosen may depend on other factors such as a desired retention time within the furnace 200 and the size (e.g., diameter and height) of the furnace 200, as would be appreciated by those having skill in the art.

A thermocouple or other temperature sensor (not shown) can be positioned within or adjacent to the furnace interior 210 to measure the temperature of the air within the furnace interior 210, which can be used to control the burner 212—i.e., to produce a larger and/or hotter flame 214 is the air temperature is below a specified set point or temperature range, or to produce a smaller and/or cooler flame 214, or to shut the flame 214 off completely, if the measured temperature is above the specified set point or temperature range. The temperature sensor must be able to withstand the high temperatures within the furnace 200 and be able to operate and accurately determine the temperature at those temperatures.

A spray nozzle 216 is placed within the furnace interior 210 to spray a liquid, solution, mixture, or slurry (labeled simply as “Liquid” in FIG. 3) into the furnace interior 210. An inlet pipe 218 feeds the spray nozzle 216 with the liquid, solution, mixture, or slurry to be sprayed into the furnace interior 210 (such as the hydrated aluminum salt solution 22 that is fed to the spray nozzle 34 in the spray roasting step 26 or the washed alumina powder 48 that is fed to the spray nozzle 56 in the spray drying step 50 of the process 10 in FIG. 1, or the second hydrated aluminum salt solution 136 fed to the spray nozzle 144 in the spray roasting step 138 of the process 100 in FIG. 2). In an example, the spray nozzle 216 is configured to disperse the liquid, solution, mixture, or slurry received from the inlet pipe 218 to form a fine mist 220 of the liquid, solution, or slurry. For example, the spray nozzle 216 can be configured to receive the liquid, solution, mixture, or slurry from the liquid inlet pipe 218 and to receive high velocity air or another mixing gas, such as from an airline 222, and the spray nozzle 216 can be configured to mix the high velocity air with the liquid, solution, mixture, or slurry to generate the fine mist 220. For example, the spray nozzle 216 can include a venturi or other structure that can combine a liquid, solution, mixture, or slurry and a gaseous feed to generate a fine mist of the liquid, solution, mixture, or slurry.

In an example, such as for the processes 10 and 100 for making high-purity alumina powder, the spray nozzle 216 is configured to spray a mist with very fine droplets (e.g., with a specified droplet size), which can then result in a product powder having particle sizes that are substantially the same as the mist droplet size. In an example, the spray nozzle 216 can produce mist droplets having an average droplet size (e.g., droplet diameter) of from about 1 micrometer (μm) to about 100 μm, for example from about 5 μm to about 85 μm, such as from about 10 μm to about 75 μm, for example from about 15 μm to about 70 μm, such as from about 20 μm to about 60 μm, for example from about 25 μm to about 50 μm.

In an example, one or both of the liquid inlet pipe 218 and the air line 222 can include one or both of the flowmeter and a control valve or other structure for modifying the flow rate through the conduit 218, 222 to control the flow rate of the liquid, solution, mixture, or slurry and/or air that is fed to the spray nozzle 216 (not shown in the figures). For example, the furnace 200 can include a first flowmeter and/or flow control valve on the liquid inlet pipe 218 to control the flow rate of the liquid, solution, mixture, or slurry to the spray nozzle 216 and/or can include a second flowmeter and/or flow control valve on the air line 222 to control the flow rate of air to the spray nozzle 216. More precise control of the flow rate of one or both of the liquid, solution, mixture, or slurry and the air to the spray nozzle 216 can allow for more precise control of the spray rate and the characteristics of the mist 220 that is generated by the spray nozzle 216. Control of the flow rate of the liquid and air being fed to the spray nozzle 216 can be particularly useful when the material being sprayed is difficult to spray evenly (e.g., without the formation of chunks or surges, especially if that material can also tend to bind or stick to the inner surfaces of the furnace refractor when the larger droplets that result from that surging come into contact with the furnace walls 202, 204, 206. For example, the spraying of PAC into a furnace for the purpose of calcination to form alumina powder is known to result in the formation of PAC chunks or large droplets that stick or bind to the furnace refractory, especially at high temperatures, unless the mist 220 has a very fine droplet sizes and is very evenly distributed by the spray nozzle 216. Such a fine and even spray mist is more easily achievable when one or both of the PAC flow rate and the air flow rate to the spray nozzle 216 are controlled to specified ranges.

Further description of various structural and material details of an example spray nozzle that can be used as the spray nozzle 216 for the furnace 200 are described in Applicant's co-pending U.S. Provisional Application No. 64/705,845, filed on Oct. 10, 2024, entitled “High Temperature And Corrosion Resistant Sprayer,” the entire disclosure of which is incorporated by reference.

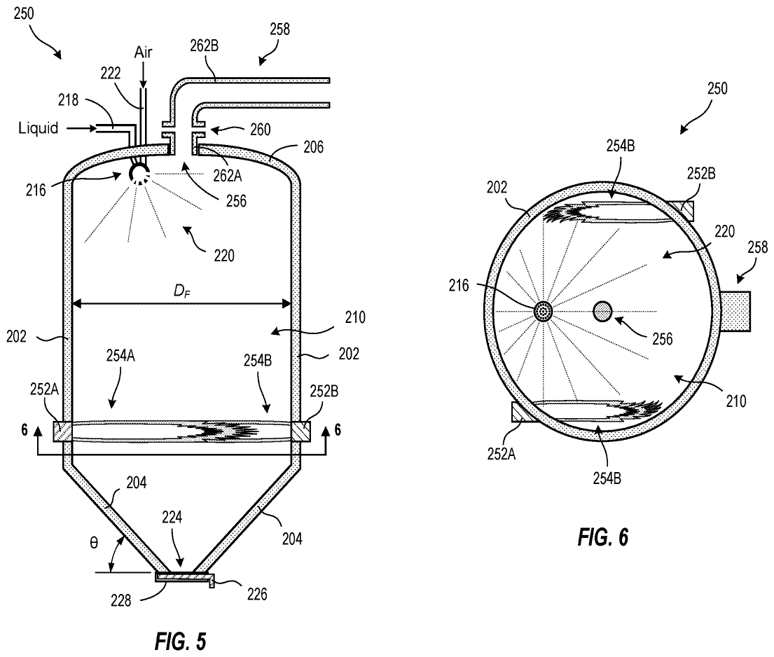

In the example shown in FIG. 3, the spray nozzle 216 is coupled to an interior surface of the domed top wall 206 generally at the center of the top wall 206. However, the spray nozzle 216 can be mounted at other locations within the furnace, such as at another location on the domed top wall 206 (such as the off-center position for the spray nozzle 216 in the furnace 250 in FIGS. 5 and 6). In other examples, not shown, the spray nozzle 216 could be mounted to the side wall 202 or to the angled bottom wall 204. The location of the spray nozzle 216 within the furnace interior 210 may require the spray nozzle 216 to be angled so that the resulting mist 220 of the liquid, solution, mixture, or slurry being sprayed is more evenly dispersed within the furnace interior 210, such as in the example orientation of the spray nozzle 216 of the furnace 250 best seen in FIG. 5. The location of the spray nozzle 216 may also require a different location or configuration of the inlet pipe 218 that is feeding the liquid, solution, mixture, or slurry to the spray nozzle 216. For example, also as seen for the furnace 250 in FIG. 5, the inlet pipe 218 comes in laterally so as not to interfere with the flue gas chimney 258, which exits the furnace interior 210 from the top center of the domed top wall 206 for the furnace 250 (FIG. 5). In some examples, the spray nozzle 216 can be mounted relative to the one or more burners 212 so that some of the mist 220 is sprayed directly into the flames 214 of the one or more burners 212 (not shown in FIG. 3, but discussed below with respect to the furnace 260 of FIGS. 7 and 8 and the furnace 270 of FIGS. 9 and 10).

The furnace 200 also includes a powder exit opening 224 through at least one of the walls 202, 204, 206 through which the desired product solids, i.e., powder (also referred to hereinafter as “product powder”), can exit the furnace interior 210 for further processing, if needed. In each of the furnaces 200, 250, 270, and 290, the opening through which the product powder exits the furnace interior 210 (i.e., the powder exit opening 224 in the furnaces 200, 250, and 270 of FIGS. 3, 5, and 7, respectively, or the powder and flue gas exit opening 296 in the furnace 290 of FIG. 9) is located at or proximate to the vertical bottom end of the furnace interior 210, although furnaces that can be used in the processes 10, 100 of FIGS. 1 and 2 or in the process 400 of FIG. 11 are not necessarily limited to the powder exit opening being located at or proximate to the vertical bottom end of the furnace. In most examples, having the powder exit opening at or proximate to the vertical bottom end of the furnace interior 210 is preferred because the liquid, solution, mixture, or slurry being sprayed into the furnace interior 210 by the spray nozzle 216 and the product powder that results after calcining or drying is more dense then the gases in the furnace interior 210, such that the liquid, solution, mixture, or slurry and the product powder will tend to flow downward due to gravity. For similar reasons, in most examples, the inlet of the liquid, solution, mixture, or slurry into the furnace interior 210 (i.e., the spray nozzle 216) is preferably located at or proximate to the vertical top end of the furnace interior 210, so that the liquid, solution, mixture, or slurry can flow through substantially the entirety of the furnace interior 210 to maximize calcination or drying of the compounds to provide the desired product powder. However, those having skill in the art will appreciate that the furnaces of the present disclosure are not required to have the spray nozzle be located at or near the vertical top end of the furnace. When the inlet of the liquid, solution, mixture, or slurry (e.g., the spray nozzle 216) is located at or proximate to the vertical top end of the furnace 200 and the powder exit opening 224 is located at or proximate to the vertical bottom end of the furnace 200, then the material being either calcined or dried by the furnace 200 flows generally in a vertical downward direction while it is being processed within the furnace 200.

In an example, the furnace 200 can include a mechanism to open and close the powder exit opening 224 and/or to change the effective size of the powder exit opening 224 to control the flow of product powder out of the furnace interior 210. Examples of the mechanism for opening and closing the powder exit opening 224 include, but are not limited to, a slide gate or a rotary valve. In the example shown in FIG. 3, the mechanism comprises a slide gate 226 coupled to a fixture 228 that is mounted to the bottom wall 204 around the powder exit opening 224. The slide gate 226 can be moved between a closed position (e.g., as shown for the slide gate 226 on the furnace 250 in FIG. 5) and an open position (e.g., as shown for the slide gate 226 on the furnaces 200 and 260 in FIGS. 3 and 7). When in the closed position, the slide gate 226 completely covers the powder exit opening 224 such that product powder cannot exit the furnace interior 210. Conversely, when in the open position, the slide gate 226 is moved entirely out of the way of the powder exit opening 224 so that product powder can flow out of the furnace interior 210. In some examples, the slide gate 226 can be movable to one or more intermediate positions between the fully closed position and the fully open position in order to select one or more different sizes of a partially closed powder exit opening 224. It might be desired to close the slide gate 226 while initially heating the furnace interior 210 so that the set point temperature or range of temperatures is achieved more rapidly or if the product powder is not being converted to a desired form (if the furnace 200 is being used as a spray roasting calcination furnace) or if the product powder is not at or below a desired moisture content (if the furnace 200 is being used as a drying furnace). By partially or completely closing the slide gate 226, the product powder can be allowed to be further circulated by the swirling air within the furnace interior 210 for a longer period of time.

As shown in the example of FIG. 3, the bottom wall 204 can be angled inwardly from the outer side wall 202 toward the powder exit opening 224 such that powder that is entrained or otherwise carried by the swirling air and gases in the furnace can strike the side wall 202 and fall to the angled bottom wall 204, where the powder can be directed via gravity toward the powder exit opening 224. The bottom wall 204 being angled toward the powder exit opening 224 can help prevent the product powder from buildup at the bottom of the furnace 200 so that the powder will instead flow out of the powder exit opening 224. In an example, the angle is provided by the bottom wall 204 being frustoconical in shape (e.g., a conical shape with the tip removed for the powder exit opening 224).

In an example, the angle θ of the bottom wall 204 relative to horizontal is selected so that the bottom wall 204 will be steep enough such that buildup of the product powder along the bottom wall 204 is avoided, especially around the powder exit opening 224, and so that the product powder will fall out of the furnace interior 210 due to gravity, where the product powder can be collected (as described in more detail below). In an example, the angle θ of the bottom wall 204 is from about 5 degrees to about 75 degrees, for example from about 30 degrees to about 70 degrees, such as from about 45 degrees to about 60 degrees.

The furnace 200 also includes a flue gas exit opening 230 through one or more of the furnace walls 202, 204, 206 through which hot flue gas can exit the furnace interior 210. A flue gas chimney 232 in fluid communication with the flue gas exit opening 230, such as by being coupled to the same one or more furnace walls 202, 204, 206 that includes the flue gas exit opening 230, so that the flue gas chimney 232. Together, the flue gas exit opening 230 and the flue gas chimney 232 are configured to receive flue gas from the furnace interior 210 and carry the flue gas away from the furnace 200. As used herein, the term “flue gas” refers the atmospheric gases, combustion gases, vaporized compounds, and small entrained solids that result from combustion within the burner 212 and/or by the flame 214 (these solids are typically referred to as “ash”) that are in the furnace interior 210 during the spray roasting or spray drying.

As will be appreciated by those having skill in the art, because of the heating of gases and the liquid, solution, mixture, or slurry within the furnace interior 210, the flue gas that enters the chimney 232 through the flue gas exit opening 230 can be very hot, e.g., as hot as the calcination temperature if the furnace 200 is configured to calcine one or more compounds in the liquid, solution, mixture, or slurry (i.e., 900-1400° C. if the liquid, solution, mixture, or slurry includes a hydrated aluminum salt compound that is being calcined to form aluminum oxide) or as hot as the drying temperature if the furnace 200 is configured for drying one or more compounds in the liquid, solution, mixture, or slurry (i.e., 400-1200° C. for spray drying an alumina powder slurry). Therefore, the flue gas chimney 232 may experience large temperature changes over time and can experience corresponding expansion or contraction due to those large temperature changes. Therefore, in an example, the flue gas chimney 232 includes a gap joint 234 between a first chimney section 236A that is coupled to one of the walls 202, 204, 206 of the furnace 200 (e.g., the side wall 202 in the example shown in FIGS. 3 and 4) and a second chimney section 236B that is separated from the first chimney section 236A by a gap. The gap between the first and second chimney sections 236A and 236B is sized so that when the first chimney section 236A becomes heated by the flue gas and expands due to thermal expansion, the first chimney section 236A will expand into the second chimney section 236B in order to accommodate expansion of the furnace 200 as a whole. In an example, the gap between the first and second chimney sections 236A and 236B is from about ⅛ inch (about 3 mm) to about ½ inch (about 13 mm), although the specific gap size chosen will depend on the material or materials that are used to make the chimney sections 236A, 236B and the expected temperature range of the flue gas that will be passing through the flue gas chimney 232. In an example, one or both of the first and second chimney sections 236A and 236B can include an interaction structure, such as the corresponding flanges 238A, 238B shown in FIGS. 3 and 4. In such an example, when the first chimney section 236A expands due to heating by the flue gas, it will expand and close the gap, and the flange 238A of the first chimney section 236A will come into contact with the flange 238B of the second chimney section 236B.

In an example, the flue gas exit opening 230 and the flue gas chimney 232 are positioned and oriented relative to the side wall 202 so the orientation of the flue gas chimney 232 is generally or substantially tangential to the circumference of the inner surface of the side wall 202. As described above, the burner 212 and the flame 214 can create a whirlwind-like flow of the gases within the furnace interior 210, particularly if the burner 212 is positioned and oriented so that the direction of the flame 214 is generally or substantially tangential to the inner surface of the side wall 202. By also positioning and orienting the flue gas chimney 232 to be generally or substantially tangential to the inner surface of the side wall 202, the whirlwind-like flow of gases within the furnace interior 210 can more directly flow out through the flue gas chimney 232 when it reaches the vertical height of the flue gas exit opening 230, as shown conceptually in FIG. 4.

In the example furnace 200 of FIGS. 3 and 4, the flue gas exit opening 230 is located at or proximate to the vertical top end of the furnace interior 210, for example at or proximate to an upper end of the side wall 202 near the domed top wall 206. Also, in the example furnace 200, the heating source, i.e., the burner 212 and the flame 214, are located at or proximate to the vertical bottom end of the furnace interior 210, such that in the example furnace 200 of FIG. 3, heated air flows in a generally vertically upward direct through the furnace interior 210. As discussed above, in the configuration of the furnace 200 shown in FIG. 3, the positioning of the inlet for the liquid, solution, mixture, or slurry into the furnace interior 210 (i.e., the spray nozzle 216) and of the outlet for the powder product (i.e., the powder exit opening 224) are such that the material being processed in the furnace interior 210 flows generally in a vertical downward direction. In other words, the configuration of FIG. 3 provides for a counter-current flow, with the material being processed (i.e., the liquid, solution, mixture, or slurry being sprayed and the resulting product powder) flowing generally in one direction through the furnace interior 210 (i.e., in a vertically downward direction in the furnace 200 of FIG. 3), and with the heated air flowing generally in an opposite direction through the furnace interior 210 (i.e., in a vertically upward direction in the furnace 200 of FIG. 3). As will be appreciated by those having skill in the art in process engineering, counter-current flow is a flow arrangement of two fluids with respect to one another in a unit operation apparatus that can be advantageous under certain situations and/or with certain materials being processed. In other configurations, described below, the furnace can be configured generally of concurrent flow, i.e., with the material being processed (i.e., the liquid, solution, mixture, or slurry being sprayed and the resultant product powder) and the heated air flowing generally in the same direction—as discussed below with respect to the furnaces 260 and 270 best seen in FIGS. 7 and 9.

Turning to FIGS. 5 and 6, a second example embodiment of a furnace 250 is shown, which can be used for spray roasting (such as in the spray roasting 26 or 138 in the processes 10 or 100) or for spray drying (such as in the spray drying 50 in the process 10). The furnace 250 is very similar to the furnace 200 of FIGS. 3 and 4 in both structure and function. For example, the furnace 250 includes one or more similar or identical furnace walls 202, 204, 206—i.e., a cylindrical side wall 202, a frustoconical bottom wall 204, and a domed top wall 206—that surround a furnace interior 210. A liquid, solution, mixture, or slurry is sprayed into the furnace interior 210 with a similar or identical spray nozzle 216, and the liquid, solution, mixture, or slurry is fed to the spray nozzle 216 by an inlet pipe 218. The resulting product powder can exit the furnace interior 210 through a similar or identical powder exit opening 222, which can be located in the bottom wall 204 at or proximate to the vertical bottom end of the furnace 250. A similar or identical slide gate 224 can be included at the powder exit opening 222 to open or close the powder exit opening 222, as described above.

The primary differences between the furnace 250 in FIGS. 5 and 6 from the furnace 200 of FIGS. 3 and 4 are the heating source, the specific location of the flue gas outlet, and the positioning of the nozzle for spraying the liquid, solution, mixture, or slurry into the furnace interior 210. Regarding the heating source, as can be seen in FIGS. 5 and 6, the furnace 250 includes a pair of burners 252A and 252B that each form a separate flame 254A and 254B, respectively, instead of the single burner 212 and single flame 214 for the furnace 200. In the example shown in FIGS. 5 and 6, the flame 254A from a first burner 252A of the pair is directed into the furnace interior 210 from the side wall 202 in a first lateral direction and the flame 254B from a second burner 252B of the pair is directed into the furnace interior 210 from the side wall 202 in a second lateral direction that is generally or substantially opposite to the first lateral direction of the first flame 254A. For example, the first burner 252A can be located on a first lateral side of the furnace interior 210 (e.g., on the left side of the furnace interior 210 in the orientations shown in FIGS. 5 and 6), while the second burner 252B can be located on an opposing second lateral side of the furnace interior 210 (e.g., on the right side of the furnace interior 210 in the orientation shown in FIGS. 5 and 6). With such positioning, the opposite directions of the flames 254A, 254B result in the two flames 254A, 254B being directed laterally toward one another into the furnace interior 210. In an example one or both of the burners 252A, 252B are positioned off-center relative to a lateral center-line through the furnace 250, for example so that one or both of the flames 254A, 254B will be located proximate to an inner surface of the side wall 202, similar or identical to the burner 212 and flame 214 in the furnace 200.

In an example, one or both of the burners 252A, 252B can be positioned and oriented so that the direction of one or both of the flames 254A, 254B are generally or substantially tangential to the circumference of the inner surface of the side wall 202. For example, as is best seen in FIG. 6, the first burner 252A can be positioned so that the first flame 254A is located at a first position along the inner surface of the side wall 202 (e.g., near the bottom edge of the furnace interior 210 as shown in the orientation of FIG. 6) and so that the first flame 254A is directed generally or substantially tangentially to the inner surface of the side wall 202 in a first direction (e.g., from left to right in the orientation of FIG. 6). The second burner 252B can be positioned so that the second flame 254B is located at a second position along the inner surface of the side wall 202 that is generally opposite to the first position of the first flame 254A (e.g., near the top edge of the furnace interior 210 as shown in the orientation of FIG. 6) and so that the second flame 254B is directed generally or substantially tangentially to the inner surface of the side wall 202 in a second direction that is generally or substantially opposite to the first direction (e.g., from right to left in the orientation of FIG. 6). The generally or substantially opposite positioning of the burners 252A, 252B and the generally or substantially tangential orientation of the flames 254A, 254B can produce the whirlwind-like circling of the gases, liquid, solution, mixture, or slurry, and product powder within the furnace interior 210 described above.

The other primary difference between the furnace 250 and the furnace 200 is the specific location of a flue gas exit opening 256 for the furnace 250 compared to the flue gas exit opening 228 for the furnace 200. Although the flue gas exit opening 256 is also located at or proximate to the vertical top end of the furnace interior 210 (such that the heated gases flows generally in a vertical upward direction similar to the furnace 200), the flue gas exit opening 256 is located in the top wall 206 instead of in the side wall 202. In the specific example shown in FIGS. 5 and 6, the flue gas exit opening 256 is located at a central location of the top wall 206. Similar to the flue gas exit opening 228 for the furnace 200, a flue gas chimney 258 is in fluid communication with the furnace interior 210 via the flue gas exit opening 256, but the flue gas chimney 258 flows upward from the top wall 206, although the flue gas chimney 258 can include a portion that is directed laterally sideways as shown in FIG. 5. As will be appreciated by a person of skill in the art, because the flue gas exit opening 256 is located at the center of the top wall 206, the spray nozzle 216 for the furnace 250 is moved to the side of the center of the top wall 206 and the inlet pipe 218 is reconfigured so that it does not interfere with the flue gas chimney 258. The spray nozzle 216 is also reoriented slightly to change the general angle that the mist 220 is directed into the furnace interior 210 for more even dispersal of the liquid, solution, mixture, or slurry in the fine mist 220.

In an example, shown in FIG. 5, the flue gas chimney 258 can include a gap joint 260 between a first chimney section 262A that is coupled to one of the furnace walls 202, 204, 206 (i.e., the top wall 206 in the example shown in FIG. 5) and a second chimney section 262B that is separated by the first chimney section 262A by a gap, similar or identical to gap joint 234 between the chimney sections 236A, 236B described above for the furnace 200. The size of the gap between the first and second chimney sections 262A, 262B for the gap joint 280 can be the same or substantially the same as the gap between the chimney sections 236A, 236B for the gap joint 234 described above.

As will be apparent to those having skill in the art, the positioning of the spray nozzle 216, the powder exit opening 222, the burners 252A, 252B, and the flue gas exit opening 256, the furnace 250 is configured for counter-current flow similar to the furnace 200. Specifically, as discussed above with the furnace 200, the spray nozzle 216 being located at or proximate to the vertical top end and the powder exit opening 222 being located at or proximate to the vertical bottom end results in the material being processed (e.g., the hydrated aluminum salt solution 22, 136 in the processes 10, 100 or an alumina powder 48 to be dried in the process 10) and the resulting product powder flowing generally in a vertical downward direction. And the burners 252A, 252B being located at or proximate to the vertical bottom end of the furnace interior 210 and the flue gas exit opening 256 being located at or proximate to the vertical top end of the furnace interior 210 results in the heated gases within the furnace 250 flowing generally in a vertical upward direction.

In contrast, FIGS. 7-10 show example embodiments of furnaces 270 and 290 that are configured for concurrent flow of both the material being processed (e.g., the liquid, solution, mixture, or slurry being calcined or dried and the resulting product powder) and the heated gases flowing generally in the same direction through the furnaces 270, 290. FIGS. 7 and 8 show a third example embodiment of a furnace 270, which can be used for spray roasting (such as in the spray roasting 26 or 138 in the processes 10 or 100) or for spray drying (such as in the spray drying 50 in the process 10). The furnace 270 includes many structures that are similar or identical to structures of the furnace 200. These can include one or more furnace walls 202, 204, 206 (e.g., a cylindrical side wall 202, a frustoconical bottom wall 204, and a domed top wall 206) surrounding a furnace interior 210 into which a liquid, solution, mixture, or slurry is sprayed with spray nozzle 216 fed by an inlet pipe 218. The resulting product powder can exit the furnace interior 210 through a similar or identical powder exit opening 222, which can be controlled by a slide gate 224.

The primary differences between the furnace 270 of FIGS. 7 and 8 and the furnace 200 of FIGS. 3 and 4 are the locations of the heating source and of the flue gas exit. As can be seen best in FIG. 7, the furnace 270 includes a single burner 272, like the single burner 212 of the furnace 200, but the burner 272 is located at or proximate to the vertical top end of the furnace interior 210 rather than at or proximate to the vertical bottom end for the furnace 200. The burner 272 produces a flame 274 that heats the furnace interior 210, and in particular will heat the fine mist 220 of the liquid, solution, mixture, or slurry that is sprayed by the spray nozzle 216, which is also located at or proximate to the vertical top end of the furnace interior 210. In an example, the burner 272 can be positioned in close proximity to the spray nozzle 216 so that at least a portion the mist 220 is sprayed directly into the flame 274 produced by the burner 272. Spaying the liquid, solution, mixture, or slurry directly into the flame 274 can be particularly useful when the purpose of the furnace 270 is calcination of one or more compounds in the liquid, solution, mixture, or slurry (e.g., to calcine the hydrated aluminum salt compounds in PAC to form alumina) because the liquid, solution, mixture, or slurry is heated to the very high temperature of the flame 274 almost immediately after being sprayed into the furnace interior 210. However, directly spraying the liquid, solution, mixture, or slurry can also be useful for spray drying.

In the example embodiment of the furnace 270 shown in FIGS. 7 and 8, the positioning and orientation of the burner 272 relative to the side wall 202 is similar or identical to that of the burner 212 in the furnace 200, except that the burner 272 is at a different vertical height. Specifically, as can be seen best in FIG. 8, the burner 272 is positioned and oriented so that the flame 274 is located proximate to the interior side of the side wall 202 and, in an example, so that the direction of the flame 274 is generally or substantially tangential to the inner surface of the side wall 202. As discussed above with respect to the furnace 200, the generally or substantially tangential orientation of the flame 274 relative to the side wall 202 can produce a whirlwind-like flow of the heated gases within the furnace interior 210.

As is also best seen in FIG. 7, the furnace 270 includes a flue gas exit opening 276 that is located at or proximate to the vertical bottom end of the furnace interior 210. As noted above, in the example furnace 270 shown, the burner 272 and its flame 274 are located at or proximate to the vertical bottom end, such that the heated gases within the furnace 270 flow generally in a vertical downward direction. As is also discussed above, because the spray nozzle 216 of the furnace 270 is located at or proximate to the vertical top end of the furnace interior 210 and the powder exit opening 222 is located at or proximate to the vertical bottom end of the furnace interior 210 so that the material being heated (i.e., one or more components of the liquid, solution, mixture, or slurry and the resulting product powder) also flow generally in a vertical downward direction. Therefore, the example furnace 270 is a configuration that provides for concurrent flow of the material being heated and the heating gases, in contrast to the counter-current flow in both furnaces 200 and 250.

Similar to the furnaces 200 and 250, the furnace 270 includes a flue gas chimney 278 that is in fluid communication with the furnace interior 210 via the flue gas exit opening 276. However, the flue gas chimney 278 for the furnace 270 is coupled at a vertically lower position of the furnace 270, such as in the bottom wall 204 as shown in FIG. 7. The flue gas chimney 278 can include a gap joint 280 between a first chimney section 282A that is coupled to one of the furnace walls 202, 204, 206 (i.e., the bottom wall 204 in the example shown in FIGS. 7 and 8) and a second chimney section 282B that is separated by the first chimney section 282A by a gap, similar or identical to gap joints 234 and 260 described above for the furnaces 200 and 250. The size of the gap between the first and second chimney sections 282A, 282B for the gap joint 280 can be the same or substantially the same as the gap between the first chimney section 236A, 262A and the second chimney section 236B, 262B for the gap joints 234 and 260 described above.

FIGS. 9 and 10 show a fourth example embodiment of a furnace 290 is shown, which can be used for spray roasting (such as in the spray roasting 26 or 138 in the processes 10 or 100) or for spray drying (such as in the spray drying 50 in the process 10). The furnace 290 is similar to the furnace 250 of FIGS. 5 and 6. For example, the furnace 290 includes one or more similar or identical furnace walls 202, 204, 206—i.e., a cylindrical side wall 202, a frustoconical bottom wall 204, and a domed top wall 206—that surround a furnace interior 210. A liquid, solution, mixture, or slurry is sprayed into the furnace interior 210 with a similar or identical spray nozzle 216, and the liquid, solution, mixture, or slurry is fed to the spray nozzle 216 by an inlet pipe 218.

The primary difference between the furnace 290 in FIGS. 9 and 10 from the furnace 250 and FIGS. 5 and 6 is the location of the heating source within the furnace interior 210 and the configuration of the outlet for the product powder and the flue gas. Regarding the heating source, the furnace 290 includes a pair of burners 292A and 292B that each form a separate flame 294A and 294B, respectively, which can be similar to the burners 252A, 252B for the furnace 250. For example, the burners 292A, 292B can be located on generally opposite sides of the furnace interior 210 and each flame 294A and 294B are directed inward from the side wall 202 in generally opposite directions, similar to the flames 254A, 254B from the burners 252A, 252B shown in FIGS. 5 and 6. For example, the flame 294A from a first burner 292A can be directed into the furnace interior 210 in a first lateral direction and the flame 294B from a second burner 292B can be directed into the furnace interior 210 in a second lateral direction that is generally or substantially opposite to the first lateral direction of the first flame 294A. With such positioning, the opposite directions of the flames 294A, 294B result in the two flames 294A, 294B being directed laterally toward one another into the furnace interior 210.

In an example, one or both of the burners 292A, 292B can be positioned and oriented so that the direction of one or both of the flames 294A, 294B are generally or substantially tangential to the circumference of the inner surface of the side wall 202 (similar to the flames 254A, 254B from the burners 252A, 252B described above for the furnace 250). For example, as is best seen in FIG. 10, the first burner 292A can be positioned so that the first flame 294A is located at a first position along the inner surface of the side wall 202 (e.g., near the bottom edge of the furnace interior 210 as shown in the orientation of FIG. 10) and so that the first flame 294A is directed generally or substantially tangentially to the inner surface of the side wall 202 in a first direction (e.g., from left to right in the orientation of FIG. 10). The second burner 292B can be positioned so that the second flame 294B is located at a second position along the inner surface of the side wall 202 that is generally opposite to the first position of the first flame 294A (e.g., near the top edge of the furnace interior 210 as shown in the orientation of FIG. 10) and so that the second flame 294B is directed generally or substantially tangentially to the inner surface of the side wall 202 in a second direction that is generally or substantially opposite to the first direction (e.g., from right to left in the orientation of FIG. 10). The generally or substantially opposite positioning of the burners 292A, 292B and the generally or substantially tangential orientation of the flames 294A, 294B can produce the whirlwind-like circling of the gases, liquid, solution, mixture, or slurry, and product powder within the furnace interior 210 described above.

The other primary difference between the furnace 290 and the furnace 250 is the configuration of the outlet for the product powder and the flue gas to exit the furnace interior 210. Rather than having separate openings for the product powder and the flue gas exits (i.e., the powder exit opening 222 and the flue gas exit opening 228, 256, or 276 in the furnaces 200, 250, 270), the furnace 290 includes a single exit opening 296 that is configured to allow both the product powder and the flue gas to exit the furnace interior 210 (also referred to as “the powder and flue gas exit opening 296”). In the example furnace 290 of FIGS. 9 and 10, the powder and flue gas exit opening 296 is located at or proximate to the vertical bottom end of the furnace interior 210, for example at the bottom end of the frustoconical bottom wall 204, as is best seen in FIG. 9. Because there is no other outlet for the flue gas, any backpressure created by the heating of the flames 294A, 294B will force both the flue gas and the product powder out through the powder and flue gas exit opening 296 and into a powder and flue gas conduit 298 that carries the product powder and flue gas away from the furnace 290. The combined product powder and flue gas stream in the powder and flue gas conduit 298 can be further processed to separate the product powder from the flue gas, such as in one or more cyclones, bag houses, or other unit operations configured to separate fine solids from a gas stream. In the example shown in FIG. 9, the furnace 290 does not include a slide gate or other mechanism to control flow through the powder and flue gas exit opening 296. However, those having skill in the art would be able to envision a slide gate or other mechanism at the powder and flue gas exit opening 296 to control flow into the powder and flue gas conduit 298.

In an example, the powder and flue gas conduit 298 can include a gap joint 300 between a first conduit section 302A and a second conduit section 302B, which can be similar to the gap joints 234, 260, and 280 for the furnaces 200, 250, and 270 described above. For example, the first conduit section 302A can be coupled to one of the furnace walls 202, 204, 206 (i.e., to the bottom wall 204 in the example shown in FIG. 9) so that it is in fluid communication with the furnace interior 210 via the powder and flue gas exit opening 296. The second conduit section 302B is separated from the first conduit section 302A by the gap joint 300 to accommodate thermal expansion of one or both of the conduit sections 302A, 302B, similar or identical to gap joints 234, 260, and 280 described above for the furnaces 200, 250, and 270. The size of the gap between the first and second conduit sections 302A, 302B for the gap joint 300 can be the same or substantially the same as the gap between the first chimney section 236A, 262A, 282A and the second chimney section 236B, 262B, 282B for the gap joints 234, 260, and 280 described above.

The furnace 290 shown in FIGS. 9 and 10 is configured for concurrent flow of the material being processed (e.g., the liquid, solution, mixture, or slurry and the resulting product powder) and the heated gases. Both the inlet of the liquid, solution, mixture, or slurry being processed (i.e., the spray nozzle 216) and the source of the heated gas (i.e., the burners 292A, 292B) are located at or proximate to the vertical top end of the furnace 290. Similarly, both outlets for the material being processed (i.e., the calcined or dried product powder) and the heated gas is located at or proximate to the vertical bottom end of the furnace 290 in the form of the common powder and flue gas exit opening 296 and the powder and flue gas conduit 298. Therefore, both the material being processed (i.e., the liquid, solution, mixture, or slurry and the resulting product powder) and the heated gas flow generally in a vertical downward direction from the vertical top to the vertical bottom of the furnace 290 in a concurrent fashion.

### Furnace Materials for Production of High-Purity Materials

In examples where a furnace 200, 250, 270, 290 is being used for a process of producing a high-purity material, such as high-purity aluminum oxide as is the case with the processes 10 and 100, it may be desirable for the material or materials that are used to form the structures of the furnace 200, 250, 270, 290 to be non-contaminating to the liquid, solution, mixture, or slurry that is being sprayed into the furnace 200, 250, 270, 290 and to the powder product that results from the spray roasting or spray drying being performed in the furnace 200, 250, 270, 290. Contamination of the liquid, solution, mixture, or slurry being sprayed or the product powder can be particularly challenging to avoid when either: (a) the desired purity of the powder product is particularly high; and/or (b) if the temperature necessary for the process being performed in the furnace interior 210 (e.g., spray drying or spray roasting of the liquid, solution, mixture, or slurry) is particularly high (such as the temperatures discussed above for spray roasting or spray drying in the furnace 200, 250, 270, 290).

High-purity aluminum oxide for artificial sapphire that is used in many applications can require an aluminum oxide purity of at least 4N (i.e., 99.99% pure aluminum oxide or higher), such as at least 4.5N (i.e., 99.995% pure aluminum oxide or higher), for example at least 4.7N (i.e., 99.997% pure aluminum oxide or higher), and as high as at least 5N (i.e., 99.999% pure aluminum oxide or higher) for some applications). It takes very little impurity added by the process of producing aluminum oxide for the purity to fall below 4N or 5N purity limits. In addition, for some applications, the amount of one or more specific impurities within the aluminum oxide must be below specified thresholds, even if the overall purity still satisfies the desired 4N or 5N aluminum oxide purity. Examples of specific impurities that must be below impurity thresholds include, but are not limited to: sodium (Na), iron (Fe), silicon (Si), titanium (Ti), magnesium (Mg), calcium (Ca), potassium (K), copper (Cu), chromium (Cr), or specific combinations thereof.

In order to avoid contamination of the liquid, solution, mixture, or slurry being sprayed into the furnace 200, 250, 270, 290 or of the resulting product powder (e.g., high-purity alumina powder), many of the structures of the furnace 200, 250, 270, 290 can be made from non-contaminating materials, that is, materials that will avoid or prevent the addition of one or more contaminants into the product powder so that the content of each of the one or more contaminants are below a specified impurity threshold, such as the impurity thresholds described above for the alumina powders 30, 44, 48, 52, 64, 142, 154, 158, 162, 166 described above with respect to the processes 10, 100 (such as the values for total impurities, total metallic impurities, total alkyl impurities, sodium (Na), iron (Fe), silicon (Si), titanium (Ti), magnesium (Mg), calcium (Ca), potassium (K), copper (Cu), chromium (Cr), or for totals of two or more of these impurities).

In particular, one material that can tend to contaminate the liquid, solution, mixture, or slurry or the resulting product powder is the material of the walls 202, 204, 206 of the furnace 200, 250, 270, 290, such as the refractory material that is used to form one or more of the walls 202, 204, 206 (e.g., refractory bricks), because the refractory material is directly exposed to the high temperatures of the gases in the furnace interior 210 and can also come into contact with a portion of the liquid, solution, mixture, or slurry or the resulting product powder during turbulent flow of gases within the furnace interior 210. As discussed above, an example of a refractory material that can be used to form each of the one or more furnace walls 202, 204, 206 include, but are not limited to, high purity alumina refractory. In particular, for the processes 10, 100 for making high-purity alumina powder described herein, alumina refractory having a low content of silica (SiO₂), such as about 0.1 wt. % SiO₂ or less, and a high alumina (Al₂O₃) content, such as at least about 99.7 wt. % Al₂O₃, can be used to form one or more of the walls 202, 204, 206 so that the refractory material will not contaminate the liquid, solution, mixture, or slurry or the resulting product powder. Examples of commercially available alumina refractory includes, but are not limited to, alumina refractory material sold by FibreCast Inc. Burlington, Ontario, Canada, such as those including Saffil fiber (although preferably Saffil is not used on an interior facing material because Saffil typical does not have a sufficiently high purity to avoid contamination by direct contact). Those will skill in the art will appreciate that for other applications, other refractory material may be used for one or more of the walls 202, 204, 206 or lower purity alumina refractor can be used.

Other structures for which its material or materials of construction might contaminate the liquid, solution, mixture, or slurry or the product powder include, for example, the material or materials that form one or more of: the one or more burners 212, 252, 272, 292; thermocouples or other sensors to measure temperature or other conditions within the furnace interior 210; the spray nozzle 216; the flue gas chimney 232, 258, 278 or the powder and flue gas conduit 298; and the mechanism for opening and closing the powder exit opening 224 (e.g., the slide gate 226 and the slide gate fixture 228).

Examples of sufficiently non-contaminating materials or materials that may contaminate but can still be used as part of the one or more burners 212, 252, 272, 292 include, but are not limited to: the alumina ceramic material sold under the trade name DURACON 34LS by Allied Mineral Products, Columbus, OH, USA, which can be used to form the burner block of the one or more burners 212, 252, 272, 292; and 316 stainless steel, which can be used to form the nozzle of the one or more burners 212, 252, 272, 292.

Examples of non-contaminating materials that can be used to form one or more structures of the spray nozzle 216 include, but are not limited to, one or more of: silicon nitride (SiN, such as Si₃N₄), graphite (e.g., crystalline or ceramic carbon, for example comprising one or more layers of natural or synthetic graphene), silicon carbide (SiC), sintered alumina (Al₂O₃) (which can provide for further temperature resistance when doped with Magnesia (MgO) and/or silica (SiO₂), zirconia (ZrO₂), and boron nitride (BN)).

In an example, the portion of the thermocouple or other temperature sensor that would be exposed to the furnace interior 210 can be placed within a sheath to prevent contamination by the material of the temperature sensor. Examples of materials that can be used to form the thermocouple sheath include, but are not limited to, high-purity and non-contaminating silicon nitride (SiN, such as Si₃N₄), high-purity and non-contaminating silicon carbide (SiC), and high-purity and non-contaminating alumina (Al₂O₃).

The flue gas chimney 232, 258, 278 (e.g., either the entire chimney if it is a single piece, or one or both of the first chimney section 236A, 262A, 282A and second chimney section 236B, 262B, 282B in the multi-section chimneys 232, 258, 278 shown in FIGS. 3, 5, and 7) or the powder and flue gas conduit 298 (either the entire conduit 298 if it is a single piece, or one or both of the first and second conduit sections 302A, 302B in the multi-section conduit 298 shown in FIG. 9) can be formed from a refractory material similar to the refractor material that is used to form the one or more furnace walls 202, 204, 206. The temperature of the gases within the flue gas chimney 232, 258, 278 and the powder and flue gas conduit 298 are expected to be lower than the temperature in the furnace interior 210 because the flue gas within the chimney 232, 258, 278 and the conduit 298 is no longer being actively heated by the one or more burners 212, 252, 272, 292. Therefore, the purity and contaminant requirements for the refractory of the flue gas chimney 232, 258, 278 and the powder and flue gas conduit 298 may, in certain examples, be less stringent than what may be necessary to be non-contaminating by refractory of the furnace walls 202, 204, 206.

In an example, the flue gas chimney 232, 258, 278 or the powder and flue gas conduit 298 can be high purity alumina bubble bricks. In some examples, high-purity mortar can be used for coupling the alumina bubble bricks together to form the flue gas chimney 232, 258, 278 or the powder and flue gas conduit 298 such as by forming one or both of the first chimney section 236A, 262A, 282A and the second chimney section 236B, 262B, 282B or one or both of the first conduit section 302A and the second conduit section 302B. In an example, no mortar is used between the refractory bricks that form one or more of the furnace walls 202, 204, 206 (or at least not for the inner layer of the refractory bricks that are exposed to the furnace interior 210), while a mortar is used between the bubble bricks of the flue gas chimney 232, 258, 278 or the powder and flue gas conduit 298. Preferably, if mortar is used, a high purity mortar that will not contaminate any product powder that may be entrained in the flue gas (e.g., that can be separated from the flue gas, such as via the process 400, described below). An example of a high-purity mortar that can be used for this purpose includes, but is not limited to, the mortar sold under the trade name RESITECT by RHI Magnesita GmbH, Vienna, Austria.

Examples of materials that can be used to make the mechanism for opening and closing the powder exit opening 224, such as a rotary valve (not shown in figures) or the slide gate 226 and fixture 228 shown in FIGS. 3, 5, and 7, include, but are not limited to, a high-temperature non-contaminating ceramic such as silicon nitride (SiN, such as Si₃N₄) or high-purity aluminum oxide.

### Downstream Processing of Flue Gas

As described above, the example furnaces 200, 250, 270, and 290 are configured to process a liquid, solution, mixture, or slurry that is sprayed into the interior 210 of the furnace 200, 250, 270, 290 by heating to provide a product powder (such as alumina powder), such as with one or more burners 212, 252, 272, 292 that produce one or more flames 214, 254, 274, 294. The flames 214, 254, 274, 294 heat the gases within the furnace interior 210 and also generate combustion product gases (also referred to as “flue gas”) and fine solids (also referred to as “ash”). Because both the product powder and the high-temperature flue gas are present in furnace 200, 250, 270, 290, it may be desirable or necessary to further process the flue gas to separate any product powder that may have been entrained in the flue gas or because there is a common outlet for both the product powder and the flue gas, such as the common powder and flue gas exit opening 296 and the common outlet conduit 298 for the furnace 290. In addition, because the overall process may include the use of compounds that may be undesirable to release into the atmosphere by venting the untreated flue gas, such as the one or more acids 20, 110 from the processes 10. 100. These undesirable compounds may, therefore, be present in the liquid, solution, mixture, or slurry that is sprayed into the furnace 200, 250, 270, 290, and it may be desirable to process the flue gas to scrub or otherwise remove the compounds before venting the flue gas to the atmosphere.

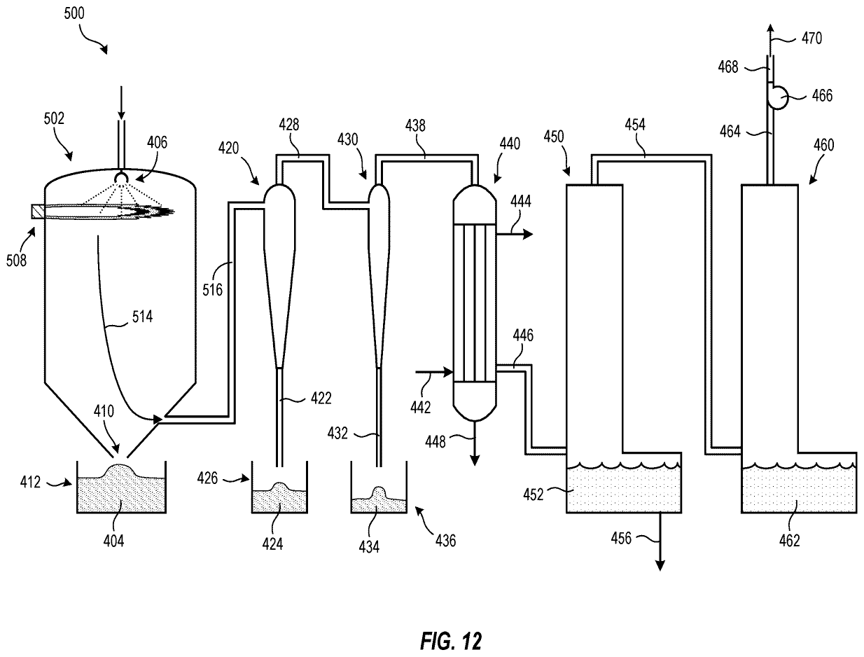

FIGS. 11 and 12 are flow diagrams example processes 400 and 500, respectively, that includes one or more unit operations to further process the flue gas (or in the case of the furnace 290, the combined powder and flue gas stream in the powder and flue gas conduit 298) to separate residual product powder from the flue gas and/or to remove one or more compounds from the flue gas. In the example shown in FIG. 11, the process 400 includes a furnace 402 that is configured for counter-current flow wherein the liquid, solution, mixture, or slurry being sprayed in a generally opposite direction from the heated gas (e.g., flue gas). For example, as shown in the example of FIG. 11, the sprayed liquid, solution, mixture, or slurry is fed into the furnace 402 at or proximate to a vertical upper end of the furnace interior so that the sprayed material flows generally in a vertically downward direction and with the heating source (e.g., a burner 408) being located at or proximate to a vertical lower end of the furnace interior so the heated gas flows generally in a vertically upward direction. The furnace 402 in the process 400 can be any counter-current furnace, such as the furnaces described herein, including, but not limited to, the calcination furnace 28 or the spray drier 54 in the process 10 of FIG. 1, the calcination furnace 140 in the process 100 of FIG. 2, or one of the example furnaces 200 and 250 of FIGS. 3-6, or varieties thereof.

In the example shown in FIG. 12, the process 500 also includes a furnace 502, which is similar to the furnace 402 in FIG. 11, except that the furnace 502 is configured for concurrent flow wherein the liquid, solution, mixture, or slurry being sprayed flows in generally the same direction as the heated gas (e.g., flue gas). For example, as shown in the example of FIG. 12, both the feed entrance of the sprayed liquid, solution, mixture, or slurry and the heating source (e.g., a burner 508) for the furnace 502 can be located at or proximate to a vertical upper end of the furnace interior so that both the sprayed material and the heated gas flow generally in a vertically downward direction. The furnace 502 in the process 500 can be any concurrent furnace, such as the furnaces described herein, including, but not limited to, the calcination furnace 28 or the spray drier 54 in the process 10 of FIG. 1, the calcination furnace 140 in the process 100 of FIG. 2, or one of the example furnaces 270 and 290 of FIGS. 7-10, or variations thereof. Other than the configuration of the furnace 502, the process 500 is substantially identical to the process 400 of FIG. 11, as described below.

The furnace 402 or the furnace 502 can be configured for one of the unit operations described herein, such as for calcination (e.g., the spray roasting 26 or 138 in the processes 10 or 100) or spray drying (e.g., the spray drying 50 in the process 10) which can provide a product powder 404 (such as the alumina powder 30 from the calcination furnace 28, the dried alumina powder 52 from the spray drier 54, or the alumina powder 142 from the calcination furnace 140). The furnace 402, 502 can include a spray nozzle 406 that is configured to spray a liquid, solution, mixture, or slurry into the interior of the furnace 402, 502, and a burner that is configured to heat the interior of the furnace 402, 502 to a specified temperature, e.g., a calcination temperature for calcining a component the sprayed liquid, solution, mixture, or slurry or a drying temperature for drying a component of the liquid, solution, mixture, or slurry. In the example counter-current furnace 402 shown in FIG. 11, the spray nozzle 406 is located at or proximate to the vertical upper end of the furnace 402 so that the sprayed mist of the liquid, solution, mixture, or slurry will flow generally in a vertically downward direction through the furnace interior, while the burner 408 is located at or proximate to the vertical lower end of the furnace 402 so that a flue gas 414 will flow generally in a vertically upward direction. In the example concurrent furnace 502 shown in FIG. 12, both the spray nozzle 406 and the burner 508 are located at or proximate to the vertical upper end of the furnace 502 so that both the sprayed mist of the liquid, solution, mixture, or slurry and a flue gas 514 will flow generally in a vertically downward direction.

In the example processes 400 and 500, the product powder 404 can exit the furnace 402, 502 through a bottom exit opening 410, where the product powder 404 can be collected by a primary powder container 412. The product powder 404 collected by the primary powder container 412 can be further processed, such as by the processing steps 42, 46, 62, 66, 70, and 74 of the process 10 or the processing steps 152, 156, 160, 164, 168, 172, 176 in the process 100.

The combustion by the burner 408, 508 generates the flue gas 414, 514, which can be carried away from the furnace 402, 502. For example, in the process 400 shown in FIG. 11, the flue gas 414 is carried from the furnace 402 by a flue gas outlet 416. In the example of FIG. 11 the flue gas outlet 416 is coupled to the furnace 204 at or proximate to a vertical upper end of the furnace 402 so that the flue gas 414 will flow generally in a vertically upward direction from the burner 408 (located at or proximate to the vertical lower end of the furnace) to the flue gas outlet 416. In the process 500, the flue gas 514 is carried from the furnace 502 by a flue gas outlet 516. In the example shown in FIG. 12, the flue gas outlet 516 is coupled to the furnace 502 at or proximate to the vertical lower end of the furnace so that the flue gas 514 will flow from the burner 508 generally in a vertically downward direction (concurrent with the mist of the liquid, solution, mixture, or slurry from the spray nozzle 406).

In both processes 400 and 500, the flue gas outlet 416, 516 can be fed into one or more cyclones 420, 430 to separate solids out of the flue gas 414, 514 using vortex/cyclonic separation. In the example shown, the flue gas outlet 416, 516 is fed into a first cyclone 420. Within the first cyclone 420, the flue gas 414, 514 flows in a helical or cyclone-like pattern, which acts to separate out fine solids particles that had been entrained in the flue gas 414, 514 and that are larger than a specified powder size from the flue gas 414, 514. The solids particles separated by the cyclone 420 are smaller than the particles in the product powder 404 that was able to fall from the furnace 402, 502 through the powder exit opening 410, and are therefore also referred to hereinafter as “secondary particles.” The secondary particles fall from the cyclone 420 through a solids outlet 422 as a secondary powder 424, which can be collected by a secondary powder container 426. The gas and any remaining solids that are too small to be separated by the configuration of the first cyclone 420 exit the first cyclone 420 through a first cyclone gas outlet 428.

In the example processes 400, 500 shown in FIGS. 11 and 12, the gas outlet 426 is fed to a second cyclone 430 that operates in much the same way as the first cyclone 420—i.e., the hot gas in the cyclone gas outlet 428 flows into the second cyclone 430 and forms a helical or cyclone-like airflow to separate even smaller solids particles (referred to as “tertiary particles”). The tertiary particles that fall from the second cyclone 430 through a solids outlet 432 as a tertiary powder 434, which can be collected by a tertiary powder container 436. The remaining gas and other fine solids exit the second cyclone 430 through a second cyclone gas outlet 438.

If the secondary powder 424 and/or the tertiary powder 434 are sufficiently pure (e.g., if the desired product is alumina powder, and the secondary powder 424 or the tertiary powder 434 has the alumina purity that is at least as high as the specified purity for the product alumina) it can be combined with the product powder 404 from the furnace 402, 502 for further processing. If, on the other hand, one or both of the secondary powder 424 and the tertiary powder 434 includes too many impurities, then one or both can either be further purified (if possible) or it can be sold as a secondary product having lower purity (e.g., as a lower purity alumina).

In an example, at least one of the one or more cyclones 420, 430 are made from non-contaminating materials with respect to the one or more product powders 424, 434 recovered by the one or more cyclones 420, 430. Examples of non-contaminating materials that can be used to form one or more of the cyclones 420, 430 include, but are not limited to, the alumina ceramic material sold under the trade name DURACON 34LS and the silicon carbide material sold under the trade name NANO-TEK ULTRA, both by Allied Mineral Products, Columbus, Ohio, USA.

As will be appreciated by those having skill in the art, the size of the particles that are able to be separated from the fed gas streams can be determined, at least in part, by the geometry of the cyclones 420, 430 (e.g., diameter, angle of cone portion, etc.) and the volumetric flow rate of the fed gas stream through the cyclones 420, 430. In an example, the first cyclone 420 is configured to separate secondary particles with an average particle size that is smaller than the average particle size of the product powder 404, but that is larger than a first specified particle size D₁, while the second cyclone 430 is configured to separate tertiary particles with an average particle size that is smaller than the first specified particle size D₁, but that is larger than a second specified particle size D₂. The specific particle sizes D1 and D2 that are chosen can depend on many factors, including, but not limited to, the expected size of ash particles produced from the combustion reaction at the burner 408, 508 (which would be expected to be very small and that would introduce impurities to the secondary powder 424 or the tertiary powder 434 if either cyclone 420 or 430 were to separate the ash particles from the gas streams); and the physical constraints of the cyclones 420, 430 (e.g., at the flow rate of the flue gas 414, 514, the size range of solids particles that the cyclones 420, 430 can capture are limited by the fluid dynamics and physical principles associated with cyclone separation).

The final product powder that results from the process 400, 500 can include just the product powder 404 from the furnace 402, 502, or can include the product powder 404 combined with one or both of the secondary powder 424 and the tertiary powder 434. In an example, the final product powder from the process 400, 500 has a median diameter (i.e., a D50 particle size of a particle size distribution) of from about 20 μm to about 75 μm, such as from about 35 μm to about 60 μm. In an example, the final product powder can have a specific surface area (SSA) (as determined by Brunauer-Emmett-Teller (BET)) of from about 2 square meters per gram (m²/g) to about 200 m²/g, for example from about 5 m²/g to about 15 m²/g, such as from 7 m²/g to about 13 m²/g, for example from about 10 m²/g to about 12 m²/g. In an example wherein the final product powder of the process 400, 500 is an alumina powder, the final alumina product powder is at least about 99.9% purity alumina, such as at least about 99.99% purity alumina, for example at least about 99.999% alumina, such as at least about 99.9999% alumina.

In the process 400, 500, because the flue gas 414, 514 exits the furnace 402, 502 at very high temperatures (e.g., as high as 1100° C. if the furnace 402, 502 is being used for spray drying an alumina powder or as high as high as 1600° C. if the furnace 402, 502 is being used to calcine a hydrated aluminum salt compound, such as PAC, to form alumina powder), the gases passing through the cyclones 420, 430 will also have very high temperatures. In an example, the process 400, 500 can include one or more heat recapturing apparatuses configured to recapture at least some of the heat from the heated gases exit the one or more cyclones 420, 430 in one or both of the gas outlets 428, 438. In the examples shown in FIGS. 11 and 12, the processes 400, 500 include one or more heat exchangers 440 that receive the heated gas (such as the gas in the cyclone gas outlet 438 from the second cyclone 430). The heat exchanger 440 can use a cooling medium 434 (such as cooling water) that is also flowed into the heat exchanger 440. Heat energy from the hot gases of the cyclone gas outlet 438 heats the cooling medium 442 and increases its temperature to provide a heated medium 444 exiting the heat exchanger 440, which could be, for example, vaporized steam. The transfer of heat energy to the cooling medium 442 results in the hot gases from the cyclone gas outlet 438 being cooled to a lower temperature to provide a cooled gas that exits the heat exchanger 440 through a heat exchanger gas outlet 446. The heated medium 444 can be used for other purposes within the plant, such as to heat some other process in the plant or to generate electricity for use in the plant or to sell back to the grid.

In some examples, the flue gas 414, 514 exiting the furnace 402, 502 can include a vapor, such as water vapor or acid vapor (e.g., in a process such as the processes 10, 100 that use one or more aqueous acids 20, 110). In such examples, the one or more heat exchangers 440 can cool the heated gases from the one or more cyclones 420, 430 such that at least a portion of the vapor condenses as a liquid condensate 448. In an example, the heat exchanger condensate 448 can be recycled back for use in another part of the process, for example for reuse as the one or more acids 20, 110 to make a hydrated aluminum salt solution (such as PAC) in the processes 10, 100. Therefore, in an example, at least the portions of the one or more heat exchangers that come into contact with the heated gases are made from a material that will not contaminate the condensate with a specified amount of one or more impurities or contaminants above. An example of a non-contaminating material that can be used to form each of the one or more heat exchangers 440 include, but is not limited to, high-purity graphite or a graphite that has been leached with an acid to remove impurities.

The process 400, 500 can include other unit operations that can remove or separate powder fines that are not captured by the one or more cyclones 420, 430. For example, the process 400, 500 can include a baghouse for separating powder fines (such as alumina powder fines) from one or more gas streams in the process 400, 500, such as from the flue gas outlet 416, 516, the first cyclone gas outlet 428, the second cyclone gas outlet 428, or the heat exchanger gas outlet 446. In a preferred example that uses a baghouse, the gas in the heat exchanger gas outlet 446 is fed to the baghouse to recover trace amounts of powder fines that had not been separated by the cyclones 420, 430.

The cooled gas in the heat exchanger gas outlet 446 may still include very fine alumina powder that was not captured by the one or more cyclones 420, 430 and/or one or more compounds that are undesirable to vent to the atmosphere (which will be referred to hereinafter as “one or more gas pollutants”). The one or more gas pollutants can include gas based compounds (such as a portion of the one or more acids 20, 110 that had not been condensed in the one or more heat exchangers 440), or other volatile compounds, including volatile organic compounds (VOCs), that may be present in the gases within the process 400, 500) or can be fine particulate (such as ash particles that result from the combustion in the burner 408, 508 or fine alumina particles that were unable to be captured by the cyclones 420, 430). Therefore, in an example, the process 400, 500 can include one or more scrubbers 450, 460 that are configured to remove at least a specified amount of fine particulate (e.g., alumina fines that was not captured by the one or more cyclones 520, 430) and/or of one or more gas pollutants from the cooled gas in the heat exchanger gas outlet 446 (or from one or more other gas streams in the process 400, 500, such as the flue gas 414, 514 in the flue gas outlet 416, 516, the hot gas exiting the first cyclone 420 in the first cyclone gas outlet 428, or the hot gas exiting the second cyclone 430 in the second cyclone gas outlet 438).

In the examples shown in FIGS. 11 and 12, the cooled gas in the heat exchanger gas outlet 446 is fed to a first scrubber 450. In an example, the first scrubber 450 includes a scrubbing medium 452 (such as a first scrubbing liquid) that is contacted by the cooled gas from the heat exchanger gas outlet 446 for a sufficient amount of time such that at least a first specified portion of fine particulate and/or of one or more gas pollutants are absorbed by and/or dissolved into and/or otherwise captured by the scrubbing medium 452 before the gas exits the first scrubber 450 through a first scrubber gas outlet 454. In an example, the gas in the first scrubber gas outlet 454 has a mass concentration (e.g., grams per liter of gas) of the fine particulate and/or the one or more gas pollutants that is lower than a first specified threshold C₁, wherein C₁ is lower than the initial concentration C₀ of the one or more gas pollutants that were in the cooled gas entering the first scrubber 450 through the heat exchanger gas outlet 446.

In an example, the process 400, 500 can include a second scrubber 460. In an example, the second scrubber 460 contains a second scrubbing medium 462 (such as a second scrubbing liquid) that is contacted by the gas from the first scrubber gas outlet 454 for a sufficient amount of time such that at least a second specified portion of the one or more gas pollutants are absorbed by and/or dissolved into and/or otherwise captured by the second scrubbing medium 462 before the gas exits the second scrubber 460 through a second scrubber gas outlet 464. In an example, the gas in the first scrubber gas outlet 454 has a concentration of the one or more gas pollutants that is lower than a second specified threshold C₂, wherein C₂ is lower than the first specified threshold C₁ of the one or more gas pollutants in the gas that exited the first scrubber 450 in the first scrubber gas outlet 454.

The scrubbers 450, 460 can have any configuration that will be effective in ensuring sufficient contact time between the gas flowing through the scrubber 450, 460 and the scrubbing media 452, 462. Types of scrubbers that can be used for one or both of the scrubbers 450, 460 can include, but are not limited to, a falling film scrubber, a packed bed scrubber, a venturi scrubber, or a spraying scrubber (such as a spray tower or a cyclone spray chamber), an orifice scrubber, or an impingement scrubber.

The scrubbing media 452, 462 used in each scrubber 450, 460 can be selected so that it can dissolve, absorb, or otherwise receive the one or more gas pollutants that are desired to be removed by that particular scrubber 450, 460. For example, if the scrubbers 450, 460 are configured to remove acid from the cooled gas, then examples of the scrubbing media 452, 462 include, but are not limited to, water, and solutions including one or more neutralizing agents dissolved or suspended in a carrying liquid.

In an example, the second scrubbing medium 462 is the same as the first scrubbing medium 452, e.g., to remove the same gas pollutant or gas pollutants in the second scrubber 460 as is removed by the first scrubber 450. In such an example, it may be that the first scrubbing medium 452 is only able to absorb a certain amount of the one or more gas pollutants to be removed in the first scrubber 450 such that a second pass through the second scrubber 460 so that the gas can contact the scrubbing medium 462 again in order to reach a desired final concentration C₂ for the one or more gas pollutants.

In another example, the second scrubbing medium 462 can be different from the first scrubbing medium 452, e.g., to remove a different gas pollutant or gas pollutants in the second scrubber 460 than what is removed by the first scrubber 460. As will be appreciated by those having skill in the art, one or more additional scrubbers with one or more additional scrubbing liquids can be added to the process 400, 500, e.g., to remove one or more additional gas pollutants from the gas before venting to the atmosphere. As will also be appreciated by those having skill in the art, one or more types of scrubbers other than the wet scrubbers, such as a dry scrubber that uses a solid absorbent medium or an electrostatic precipitator, can be used in place of or in addition to one or both of the wet scrubbers 450, 460 described above.

In a specific example, the first scrubber 450 can be configured as an acid scrubber configured to remove additional acid from the heated gas in the heat exchanger gas outlet 446 that was not condensed in the one or more heat exchangers 440, while the second scrubber 460 can be configured as a neutralization scrubber to neutralize all or substantially all of any trace of acid remaining in the gas of the first scrubber gas outlet 454. In such an example, the first scrubbing medium 452 can be high-purity water that can dissolve at least some of the acid vapor from the gases of the heat exchanger gas outlet 446 and the second scrubbing medium 462 can comprise sodium oxide (NaO) or lime (CaO) dissolved in water that neutralizes remaining acid before it is vented to the atmosphere. In an example, the acid that is captured by the first scrubbing medium 452 and/or the second scrubbing medium is recycled for use in making a hydrated aluminum salt solution, such as PAC. In an example, the acid that is captured by the first scrubbing medium 452 and/or by the second scrubbing medium 462 can be combined with acid that has been condensed by the one or more heat exchangers 440, with the combined acid being recycled for use in another part of the process.

In an example, the gas leaving the one or more scrubbers 450, 460 in the one or more scrubber gas outlets 454, 464 is withdrawn with a blower or exhaust fan 466. In an example, the exhaust fan 466 can create a vacuum force to pull the gas in the scrubber gas outlet 464 from the scrubber 460, which in turn can pull the gases through the entire process 400, 500 all the way back to the furnace 402, 502. In an example, the exhaust fan 466 can provide sufficient vacuum force so that there is a negative pressure within the furnace 402, 502 (e.g., a pressure below atmospheric pressure) of less than 0 inches of water column (IWC) (0 pascals, Pa), such as up to negative 0.05 IWC (about −12.5 Pa), up to negative 0.1 IWC (about −25 Pa), up to negative 0.15 IWC (about −37.5 Pa), up to negative 0.2 IWC (about −50 Pa), up to negative 0.25 IWC (−62 Pa), up to negative 0.3 IWC (−75 Pa), up to negative 0.4 IWC (−100 Pa), or up to negative 0.5 IWC (about −125 Pa). The exhaust fan 466 can then feed the gas to a gas stack 468 that releases a vented gas 470 to the atmosphere.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A process for preparing high-purity aluminum oxide, the process comprising:
providing an aluminum feedstock;
reacting the aluminum feedstock with one or more acids to form a hydrated aluminum salt solution; and
calcining the hydrated aluminum salt to form an aluminum oxide powder.

2. The process of claim 1, further comprising washing the aluminum feedstock with one or more of water, an acid, a base, a surfactant, a solvent, and an alcohol to remove surface impurities prior to reacting the aluminum feedstock with the one or more acids.

3. The process of claim 1, wherein the one or more acids comprise sulfuric acid (H₂SO₄), nitric acid (HNO₃), phosphoric acid (H₃PO₄), hydrochloric acid (HCl), and hydrofluoric acid (HF), or any combination thereof.

4. The process of claim 1, wherein the hydrated aluminum salt solution is a polyaluminum chloride (PAC) solution.

5. The process of claim 1, wherein calcining is performed by spraying the hydrated aluminum salt solution into a calcination furnace.

6. The process of claim 1, further comprising processing the aluminum oxide powder by milling, crushing, or tumbling.

7. The process of claim 1, further comprising subjecting the aluminum oxide powder to a magnetic field to remove magnetic impurities therefrom.

8. The process of claim 1, further comprising:
washing the aluminum oxide powder with water, an acid, or a combination thereof;
drying the washed aluminum oxide powder; and
sintering the dried aluminum oxide powder.

9. The process of claim 8, further comprising melting the sintered aluminum powder to form sapphire therefrom.

10. A process for preparing high-purity aluminum oxide, the process comprising:
providing an aluminum feedstock;
reacting the aluminum feedstock with one or more acids to form a first hydrated aluminum salt solution;
precipitating at least a portion of the hydrated aluminum salt from the first hydrated aluminum salt solution to produce a mixture of precipitated hydrated aluminum salt crystals and a mother liquor;
separating the precipitated hydrated aluminum salt crystals from the mother liquor;
dissolving the hydrated aluminum salt crystals in a solvent to form a second hydrated aluminum salt solution; and
calcining hydrated aluminum salt of the second hydrated aluminum salt solution to form an aluminum oxide powder.

11. The process of claim 10, wherein calcining is performed by spraying the hydrated aluminum salt solution into a calcination furnace.

12. The process of claim 10, further comprising:
washing the aluminum oxide powder with water, an acid, or a combination thereof;
drying the washed aluminum oxide powder; and
sintering the dried aluminum oxide powder.

13. The process of claim 12, further comprising melting the sintered aluminum powder to form sapphire therefrom.

14. A furnace comprising:
a cylindrical or substantially cylindrical side wall;
a frustoconical bottom wall coupled to and angled inwardly from a vertical bottom end of the cylindrical side wall to vertically cover the bottom of the furnace interior;
a domed or rounded top wall coupled to a vertical top end of the cylindrical side wall and vertically covering the top of the furnace interior;
one or more combustion burners configured to direct a flame toward the furnace interior with a velocity of flame creating an air flow within the furnace interior;
a inlet for supplying a material to be dried or calcined by the furnace; and
an outlet for exit of a dried or calcined material from the furnace.

15. The furnace of claim 14, wherein the inlet comprises a spray nozzle.

16. The furnace of claim 14, wherein the top wall comprises the inlet.

17. The furnace of claim 14, wherein the furnace comprises two combustion burners.

18. The furnace of claim 18, wherein the two combustion burners are configured to produce a counter-current air flow in the furnace interior.

19. The furnace of claim 18, wherein the two combustion burners are configured to produce a whirlwind-like air flow in the furnace interior.

20. The furnace of claim 14, further comprising a second outlet of exit of a flue gas.
